(19) United States
(12) Patent Application Publication
(10) Pub. No.: US 2017/0257608 A1
(43) Pub. Date: Sep. 7, 2017

(54) PROJECTION APPARATUS AND CONTROL METHOD THEREOF

(71) Applicant: CANON KABUSHIKI KAISHA, Tokyo (JP)

(72) Inventors: Takeshi Ikeda, Ebina-shi (JP); Kenichi Morikawa, Kawasaki-shi (JP)

(21) Appl. No.: 15/446,817

(22) Filed: Mar. 1, 2017

(30) Foreign Application Priority Data
Mar. 2, 2016 (JP) 2016-040369

(51) Int. Cl. H04N 9/31; G06T 11/60

(52) U.S. Cl. CPC H04N 9/3155; H04N 9/3147; H04N 9/3164; H04N 9/3185; G06T 11/60

(57) ABSTRACT

A projection apparatus includes: a light-emitting unit configured to include a plurality of light sources, a control unit configured to individually control emission amounts of the plurality of light sources of the light-emitting unit, a first processing unit configured to adjust brightness of pixels in a superimposition region, where superimposition is made with an image projected onto a screen by another projection apparatus, in input first image data and output the adjusted image data as second image data, and a projecting unit configured to project light obtained by modulating light from the light-emitting unit onto the screen, wherein the control unit controls an emission amount of a light source at a position corresponding to the superimposition region.

### BACKGROUND OF THE INVENTION

Field of the Invention

The present invention relates to a projection apparatus and a control method thereof.

Description of the Related Art

Projection apparatuses (projectors) having a solid-state light source such as an LED (light-emitting diode) are available. Solid-state light sources are widely used in liquid crystal display apparatuses such as liquid crystal television sets. With respect to liquid crystal display apparatuses using an LED as a light source for a backlight, techniques are being developed for improving contrast by local dimming. Local dimming refers to a technique that allows an emission amount (brightness) of a plurality of LEDs included in a backlight to be individually controlled in accordance with a characteristic value (for example, brightness) of an image corresponding to each light source (for example, refer to Japanese Patent Application Laid-open No. 2002-099250). Even in projectors, the use of a solid-state light source enables contrast to be improved by local dimming.

With respect to a display apparatus performing local dimming, there is a technique (dark part priority processing) which causes a light source corresponding to a display region of an image in which a high-brightness object with a small area is present against a dark background to be lighted darkly despite the presence of the high-brightness object (for example, refer to Japanese Patent Application Laid-open No. 2013-218098). Whether or not this processing is performed is determined based on a characteristic value related to brightness of the image For example, when a difference between a maximum value of the brightness of an image and an average value of the brightness of the image is larger than a prescribed threshold, it is determined that the image includes a high-brightness object with a small area against a dark background and the light source is lighted darkly. Accordingly, an occurrence of a halo or black floating can be reduced and display image quality can be improved.

When a projector cannot be installed so as to diametrically oppose a projection surface (a screen), a geometric distortion (a trapezoidal distortion) is created in a projection image on the screen. There is a technique (keystone correction) for subjecting a projection image to image processing of a geometric deformation in order to correct a trapezoidal distortion (for example, refer to Japanese Patent Application Laid-open No. 2005-123669).

Meanwhile, multi-projection systems are available which superimpose projection images projected by a plurality of projectors in a prescribed region to project and display a single large image. There s a technique (an edge-blend process) which enables a seam between projection images in a superimposition region (an edge-blend region) of the projection images to be displayed smoothly by adjusting brightness of an image in the edge-blend region of each projection image (for example, refer to WO 2011/064872). When each projector cannot be installed so as to diametrically oppose a screen in a multi-projection system, both keystone correction and an edge-blend process must be executed.

### SUMMARY OF THE INVENTION

When performing local dimming in each projector constituting a multi-projection system, an emission amount of each light source of a backlight is favorably controlled based on an image after keystone correction. This is because a position and/or a shape of an image may change due to keystone correction. On the other hand, an edge-blend process is favorably performed before keystone correction. This is because an edge-blend process must be performed in consideration of a position of superimposition of projection images of adjacent projectors and, once images are deformed by keystone correction, positioning and the like become more difficult

Accordingly, when performing local dimming in each projector constituting a multi-projection system, an emission amount of each light source of a backlight is favorably controlled based on an image obtained after performing an edge-blend process and keystone correction on an input image. However, in a case where dark part priority processing is performed when controlling an emission amount of a light source, since the dark part priority processing is performed based on a characteristic value related to brightness of an image, a change in the brightness of the image due to the edge-blend process may prevent the emission amount of the light source from being controlled in an appropriate manner. As a result, there is a problem in that a halo phenomenon and black floating cannot be sufficiently reduced.

In consideration thereof, an object of the present invention is to provide a technique for improving image quality of a projection image when performing local dimming in each projector constituting a multi-projection system.

The present invention is a projection apparatus, comprising, a light-emitting unit configured to include a plurality of light sources, a control unit configured to individually control emission amounts of the plurality of light sources of the light-emitting unit, a first processing unit configured to adjust brightness of pixels in a superimposition region, where superimposition is made with an image projected onto a screen by another projection apparatus, in input first image data and output the adjusted image data as second image data, and a projecting unit configured to project light obtained by modulating light from the light-emitting unit, based on the second image data, onto the screen and displays an image, wherein the control unit controls an emission amount of a light source at a position corresponding to the superimposition region, based on the first image data of the superimposition region.

The present invention is a projection apparatus, comprising, a light-emitting unit configured to include a plurality of light sources, a control unit configured to individually control emission amounts of the plurality of light sources of the light-emitting unit, a first processing unit configured to adjust brightness of pixels in a superimposition region, where superimposition is made with an image projected onto a screen by another projection apparatus, in input first image data and that outputs the adjusted image data as second image data, second processing unit configured to deform a shape of an image of the second image data and that outputs the deformed image data as third image data, and a projecting unit configured to project light-obtained by modulating light from the light-emitting unit, based on the third image data, onto the screen and displays an image, wherein the control unit controls, based on the first image data, an emission amount of a light source at a position corresponding to a deformed superimposition region, which has been deformed by the second processing unit.

The present invention is a control method of a projection apparatus including a light-emitting unit having a plurality of light sources, the control method comprising, controlling individually emission amounts of the plurality of light sources of the light-emitting unit, adjusting brightness of pixels in a superimposition region, where superimposition is made with an image projected onto a screen by another projection apparatus, in input first image data and outputting the adjusted image data as second image data, and projecting light obtained by modulating light from the light-emitting unit, based on the second image data, onto the screen and displaying an image, wherein in the control of emission amounts, an emission amount of light source at a position corresponding to the superimposition region is controlled based on the first image data of the superimposition region.

The present invention is a control method of a projection apparatus including a light-emitting unit having a plurality of light sources, the control method comprising, controlling individually emission amounts of the plurality of light sources of the light-emitting unit, adjusting brightness of pixels in a superimposition region, where superimposition is made with an image projected onto a screen by another projection apparatus, in input first image data and outputting the adjusted image data as second image data, deforming a shape of an image of the second image data and outputting the deformed image data as third image data, and projecting light obtained by modulating light from the light-emitting unit, based on the third image data, onto the screen and displaying an image, wherein in the control of emission amounts, an emission amount of a light source at a position corresponding to a deformed superimposition region deformed in the deforming is controlled based on the first image data.

According to the present invention, image quality of a projection image when performing local dimming in each projector constituting a multi-projection system can be improved.

Further features of the present invention will become apparent from the following description of exemplary embodiments with reference to the attached drawings.

### BRIEF DESCRIPTION OF THE DRAWINGS

FIG. 1 is a diagram showing a configuration of a multi-projection system according to a first embodiment;

FIG. 2 is a diagram showing a configuration of an edge-blend processing unit 6;

FIG. 3 is a diagram for explaining an edge-blend region;

FIG. 4 is a diagram showing a relationship between an adjustment coefficient and a pixel position in an edge-blend process;

FIGS. 5A and 5B are diagrams showing a change in an image before and after an edge-blend process;

FIGS. 6A to 6C are diagrams showing a relationship between deformation and blocks of an image before and after keystone correction;

FIGS. 7A and 7B are diagrams showing an example of a first characteristic value acquired by a first characteristic value acquiring unit 8;

FIGS. 8A and 8B are diagrams showing an example of a second characteristic value acquired by a second characteristic value acquiring unit 9;

FIG. 9 is a diagram showing a configuration of a characteristic value determining unit 10;

FIGS. 10A and 10B are diagrams showing an example of a third characteristic value of a second blended block;

FIGS. 11A and 11B are diagrams showing an example of a third characteristic value of a projector 1;

FIGS. 12A and 12B are diagrams showing an example of a third characteristic value of a projector 2;

FIG. 13 is a diagram showing a comparison of third characteristic values of the projector 1 and the projector 2;

FIGS. 14A to 14D are diagrams showing an example of a fourth characteristic value of the projector 1;

FIG. 15 is a diagram showing a configuration of an emission amount determining unit;

FIGS. 16A and 16B are diagrams showing a relationship among a fourth characteristic value (a maximum value, an average value), a first emission amount, and gain;

FIGS. 17A to 17C are diagrams showing examples of a first emission amount, gain, and a second emission amount;

FIG. 18 is a diagram showing a configuration of a multi-projection system according to a second embodiment;

FIGS. 19A to 19C are diagrams showing an example of different block sizes and correspondences of two projectors; and

FIGS. 20A and 20B are diagrams showing an example of different block sizes and correspondences of two projectors.

### DESCRIPTION OF THE EMBODIMENTS

### First Embodiment

A first embodiment of the present invention will be described below.

As the first embodiment, an embodiment of the present invention will be described using an example of a multi-projection system constituted by two projection apparatuses (projectors) which perform local dimming. In the multi-projection system, two projection images projected by the two projectors are arranged side by side and superimposed in a prescribed superimposition region (an edge-blend region) to project a single image.

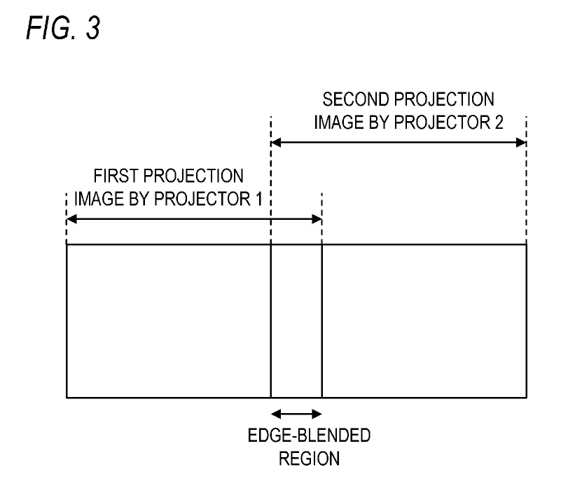

FIG. 3 is a diagram conceptually showing a first projection image by a first projection apparatus (a projector 1), a second projection image by a second projection apparatus (a projector 2), and an edge-blend region in which the projection images are superimposed in the multi-projection system according to the first embodiment. As shown in FIG. 3, in the first embodiment, the projection image by the projector 1 is on a left side of an entire projection image and the projection image by the projector 2 is on a right side of the entire projection image. As shown in FIG. 3, by superimposing the projection image by the projector 1 and the projection image by the projector 2 in the edge-blend region, a horizontally-long image is obtained as the entire projection image. In the first embodiment, the edge-blend region is set along end sections (left and right sides) in a horizontal direction of the projection image each projector. In the projection image by the projector 1, a prescribed range along the right side is the edge-blend region and, in the projection image by the projector 2, a prescribed range along the left side is the edge-blend region.

Moreover, the number of projectors constituting the multi-projection system and an arrangement method of the projection images shown in FIG. 3 are simply an example and the present invention is not limited to this example. For example, the present invention is also applicable to a multi-projection system in which three projection images are arranged side by side or to a multi-projection system in which a total of four projection images are arranged in a two-by-two pattern.

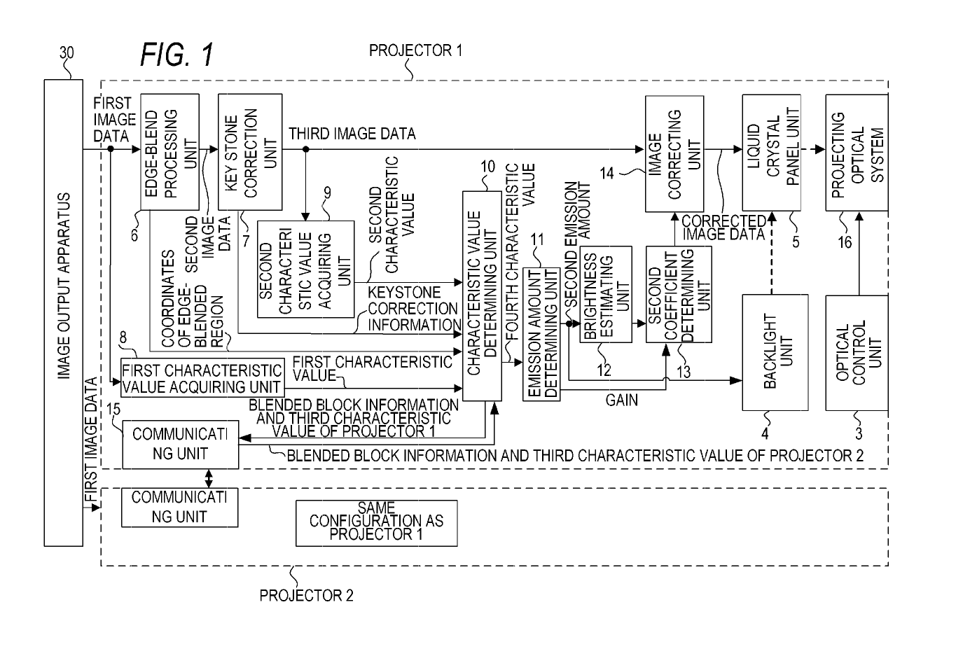

FIG. 1 is a diagram showing a functional configuration of the multi-projection system according to the first embodiment. The multi-projection system shown in FIG. 1 includes the projector 1, the projector 2, and an image output apparatus 30. The projector 1 and the projector 2 share a same functional configuration. The image output apparatus 30 outputs images to be input to the projector 1 and the projector 2. Images output to the respective projectors from the image output apparatus 30 are common in partial regions This enables a projection image by the projector 1 and a projection image by the projector 2 to be superimposed in the partial regions An edge-blend region is set in the partial regions.

The projector 1 includes a projecting optical system 16, an optical control unit 3, a backlight unit 4, a liquid crystal panel unit 5, an edge-blend processing unit 6, a keystone correction unit 7, a first characteristic value acquiring unit 8, a second characteristic value acquiring unit 9, a characteristic value determining unit 10, an emission amount determining unit 11, and a brightness estimating unit 12. The projector 1 further includes a second coefficient determining unit 13, an image correcting unit 14, and a communicating unit 15. Hereinafter, the respective functions will be described.

The projecting optical system 16 projects light transmitted through the liquid crystal panel unit 5 onto a screen which is a projection surface. Accordingly, an image formed on the liquid crystal panel unit 5 is projected onto and displayed on the screen. The projecting optical system 16 includes a plurality of lenses and an actuator which drives the lenses. Focal point adjustment, enlargement and reduction of a projection image, and the like are performed by adjusting lens positions using the actuator.

The optical control unit 3 controls the projecting optical system 16 based on an instruction from a user. Accordingly, focal point adjustment, enlargement and reduction of a projection image, and the like in accordance with the user's instruction are performed. Alternatively, a configuration may be adopted in which the optical control unit 3 controls the projecting optical system 16 based on an instruction from the system instead of an instruction from the user. For example, in a conceivable configuration, the projector 1 includes a photographic unit which photographs the screen, a degree of focusing is estimated based on an image analysis process or the like performed with respect to a projection image photographed by the photographic unit, and a focusing position is automatically adjusted based on an estimation result.

The backlight unit 4 is a light-emitting unit with a plurality of light sources of which brightness can be individually controlled, and includes a control circuit which controls the respective light sources and an optical unit for diffusing light from the light sources. The backlight unit 4 according to the first embodiment has a total of 10 light sources, with eight of the light sources being arranged in a horizontal direction and five of the light sources being arranged in a vertical direction. Each light source of the backlight unit 4 is controlled based on an emission amount determined by the emission amount determining unit 11 and is lighted at brightness in accordance with the emission amount. Moreover, the number and an arrangement method of the light sources are not limited to this example. Each light source is constituted by one or a plurality of light-emitting elements. In the first embodiment, an LED (light-emitting diode) is used as the light-emitting element. The light-emitting element is not limited to an LED as long as brightness of the light-emitting element can be controlled.

The liquid crystal panel unit 5 is a modulating unit which modulates light from the backlight unit 4 based on image data and includes a liquid crystal driver, a control substrate which controls the liquid crystal driver, and a liquid crystal panel. The modulating unit is not limited to a liquid crystal panel as long as a function of modulating light from the backlight unit 4 based on image data is provided. For example, a panel using a micro electro mechanical system (MEMS) shutter system can also be used.

<Edge-Blend>

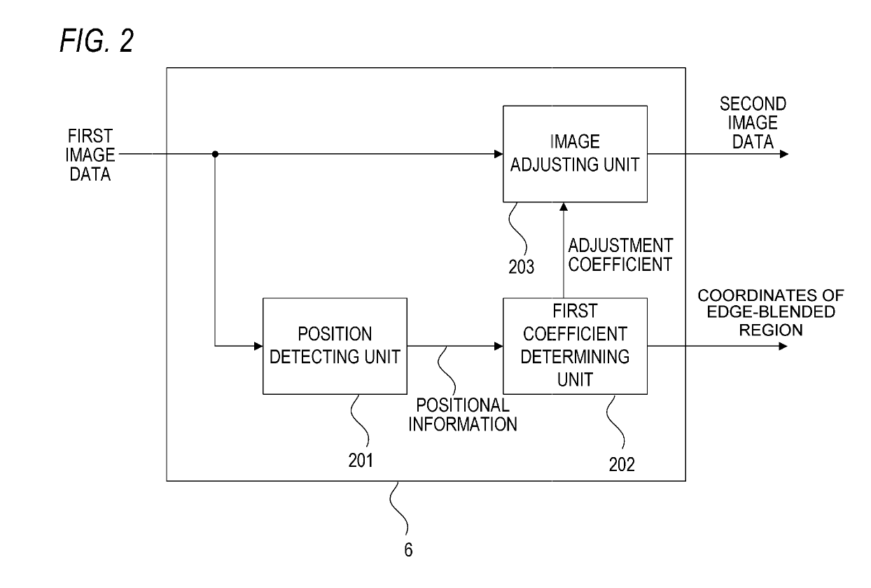

The edge-blend processing unit 6 performs a first process in which image data (first image data) input to the projector 1 is subjected to an edge-blend process and output as second image data. An edge-blend process refers to a process of adjusting (reducing) brightness of pixels in an edge-blend region. While projection images by two projectors are superimposed in the edge-blend region, by adjusting brightness of pixels in the edge-blend process, a seam between the projection images in the edge-blend region can be displayed in a smooth manner. A detailed functional configuration of the edge-blend processing unit 6 is shown in FIG. 2.

The edge-blend processing unit 6 includes a position detecting unit 201, a first coefficient determining unit 202, and an image adjusting unit 203. Hereinafter, details of the respective functions will be described. The edge-blend processing unit 6 sequentially performs the following processes on each pixel constituting the input first image data.

The position detecting unit 201 detects coordinates of a pixel that is a processing object in order to determine whether or not the processing object pixel belongs to the edge-blend region. As shown in FIG. 3, since the edge-blend region of the projection image of the projector 1 is set along a right side of the projection image, whether or not the processing object pixel belongs to the edge-blend region can be determined based on a horizontal coordinate of the pixel. Therefore, the position detecting unit 201 detects the horizontal coordinate of the processing object pixel. The position detecting unit 201 detects the horizontal coordinate of the processing object pixel based on a horizontal synchronization signal and a vertical synchronization signal of the first image data and on information related to a size (the number of pixels in the horizontal direction×the number of pixels in the vertical direction) of a display panel. The position detecting unit 201 outputs information on the detected coordinate to the first coefficient determining unit 202.

Moreover, while the present invention can also be applied to a multi-projection system in which projection images by two projectors are arranged and superimposed in the vertical direction, in this case, the edge-blend region is set in end sections (upper and lower sides) in the vertical direction of the projection images. In this case, whether or not a processing object pixel belongs to the edge-blend region can be determined based on a vertical coordinate of the pixel. Therefore, the position detecting unit 201 detects the vertical coordinate of the processing object pixel. Moreover, since the position detecting unit 201 need only be capable of acquiring positional information for determining whether or not the processing object pixel belongs to the edge-blend region, the position detecting unit 201 may detect both the horizontal coordinate and the vertical coordinate of the processing object pixel regardless of an arrangement mode of the projection images.

The first coefficient determining unit 202 determines an adjustment coefficient in accordance with the horizontal coordinate of the processing object pixel and outputs the adjustment coefficient to the image adjusting unit 203. The adjustment coefficient is a coefficient used for adjusting brightness of a pixel belonging to the edge-blend region by the image adjusting unit 203.

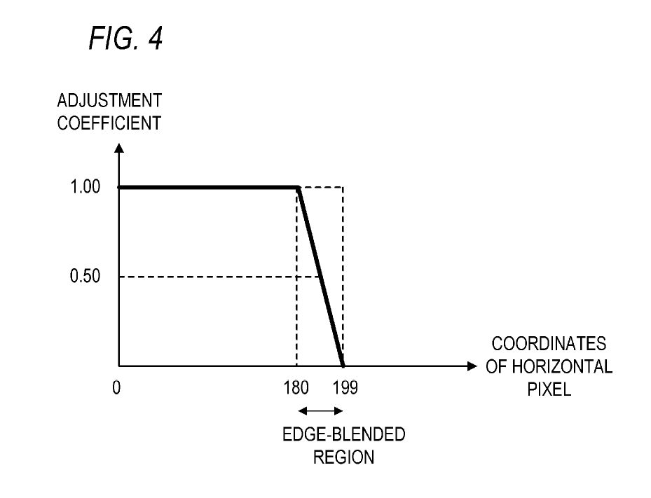

The first coefficient determining unit 202 of the projector 1 stores information on a correspondence between horizontal coordinates and values of the adjustment coefficient such as that shown in FIG. 4 in, for example, a lookup table format. The first coefficient determining unit 202 reads and determines a value of the adjustment coefficient in accordance with the horizontal coordinate of the processing object pixel from the lookup table and transmits information on the determined adjustment coefficient to the image adjusting unit 203.

In the first embodiment, it is assumed that the number of pixels in the horizontal direction of the liquid crystal panel (the number of pixels in the horizontal direction of a projection image) is 200 and a horizontal coordinate of a pixel belonging to the edge-blend region ranges from 180 to 199. As shown in FIG. 4, an adjustment coefficient applied to pixels of which a horizontal coordinate ranges from 0 to 179 is constant with a value of 1.00, and there is no change to brightness of these pixels due to the edge-blend process. An adjustment coefficient applied to pixels of which a horizontal coordinate ranges from 180 to 199 (pixels belonging to the edge-blend region) changes in accordance with the coordinate and the closer a pixel is to an end section (a right side) of the image, the closer the adjustment coefficient is to 0. Therefore, with a pixel belonging to the edge-blend region, brightness is adjusted in the edge-blend process such that the closer the pixel is to the end section (the right side) of the image, the darker the brightness of the pixel.

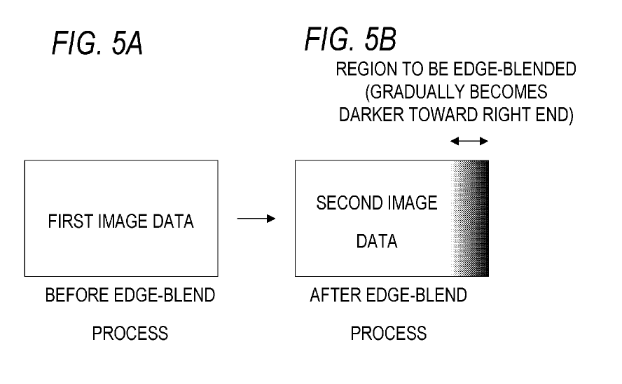

The image adjusting unit 203 multiplies the first image data with the adjustment coefficient acquired from the first coefficient determining unit 202 and generates second image data. For example, when first image data such as that shown in FIG. 5A is input, the second image data after the edge-blend process is an image of which gradation gradually decreases (becomes darker) toward the right side of the image in the edge-blend region as shown in FIG. 5B.

In the projector 2, adjustment of brightness with respect to pixels in the edge-blend region is performed in a similar manner to the process in the projector 1 described above. In the projector 2, in the edge-blend region set along a left side of an image, adjustment is performed such that gradation gradually decreases toward the left side. Therefore, when images in the edge-blend region respectively projected by the two projectors are superimposed, final brightness of the edge-blend region sprayed on the projection surface is equivalent to brightness assumed by the first image data (original image data). For example, when all pixels of the first image data are white (a maximum gradation value), by projecting images after the edge-blend process and superimposing the images in the edge-blend region, an entirely white image with even brightness is displayed on the projection surface.

As described above, in the multi-projection system according to the first embodiment, after performing an edge-blend process for reducing brightness on an image of an edge-blend region to be superimposed with a projection image by an adjacent projector, edge-blend regions are superimposed and projected. Accordingly, a seam between the projection images in the edge-blend region can be smoothly displayed and the projection of a large image obtained by compositing a plurality of projection images can be performed with high image quality. The edge-blend processing unit 6 outputs image data (second image data) after the edge-blend process to the keystone correction unit 7.

<Keystone Correction>

The keystone correction unit 7 performs a second process in which image data (second image data) after the edge-blend process is subjected to keystone correction and output as third image data. Keystone correction refers to a process of correcting a geometric deformation (referred to as a trapezoidal distortion) of a projection image that is projected onto a screen from the projecting optical system 16 and involves performing a process of deforming a shape of an image on image data. A specific method of keystone correction is described in, for example, Japanese Patent Application Laid-open No. 2013-218098.

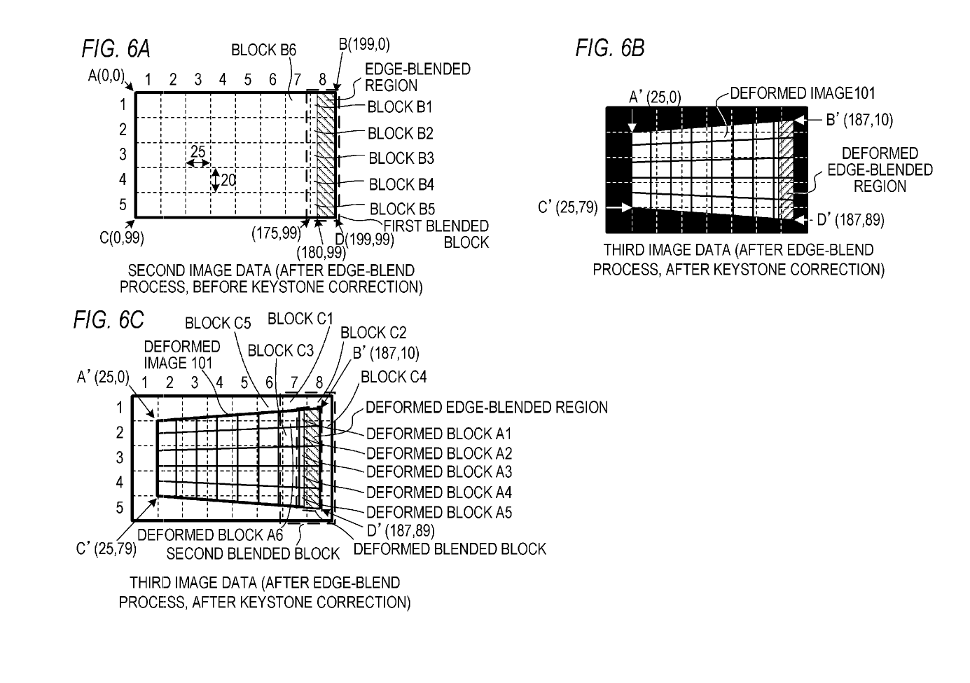

FIG. 6A is a diagram conceptually showing second image data (image data after the edge-blend process and before keystone correction), and FIGS. 6B and 6C are diagrams conceptually showing third image data (image data after keystone correction). In the following description, an uppermost and leftmost, point, of an image is assumed to be an origin (0, 0) of coordinates, and a pixel at a position of x-number of pixels in a horizontal direction and y-number of pixels in a vertical direction from the origin is to be expressed by coordinates (x, y).

An 8 horizontal×5 vertical rectangular grid depicted by dashed lines in FIGS. 6A to 6C represents a block of an image corresponding to each of the plurality of light sources of the backlight unit 4. It is assumed that the number of pixels in image data is 200 horizontal pixels×100 vertical pixels and that the number of pixels in each block is 25 horizontal pixels×20 vertical pixels. A hatched region set along the right side of the second image data represents an edge-blend region. In the first embodiment, horizontal coordinates of the edge-blend region in the second image data are assumed to range from 180 to 199.

A shape of the image of the second image data before keystone correction shown in FIG. 6A is a rectangle having a point A (0, 0), a point B (199, 0), a point C (0, 99), and a point D (199, 99) as vertices. Due to keystone correction, the rectangular image is deformed into a deformed image 101 shown in FIGS. 6B and 6C. The deformed image 101 is a quadrilateral having a point A′ (25, 20), a point B′ (187, 10), a point C′ (25, 79), and a point D′ (187, 89) in the third image data after keystone correction as vertices and does not necessarily form a rectangle. In this manner, keystone correction deforms a shape of an image in the horizontal direction and the vertical direction. In the first embodiment, due to keystone correction, the image of the second image data is compressed by 10% from a left side toward a right side and compressed by 5% from the right side toward the left side in the horizontal direction and, at the same time, compressed by 10% both upward and downward (left side) and compressed by 5% both upward and downward (right side) in the vertical direction. The compression rate in the vertical direction gradually increases from the right side to the left side.

Moreover, keystone correction can be performed by the user by inputting an instruction related to deformation to the projector 1 using an input apparatus provided on a main body or on a remote controller while viewing a projection image.

The number of pixels of the third image data after keystone correction must be the same as the number of pixels of the second image data prior to keystone correction. Therefore, the keystone correction unit 7 uses dummy data (for example, a black image) for pixels other than the deformed image 101 that is shown completely colored in black in FIG. 6B.

The keystone correction unit 7 outputs the third image data generated in this manner to the image correcting unit 14 and the second characteristic value acquiring unit 9. Moreover, various existing techniques can be used as a specific processing method of keystone correction and the processing method is not limited to the method described in Japanese Patent Application Laid-open No. 2013-218098.

<Details of Block Deformation>

Deformation of the edge-blend region by keystone correction and a positional relationship between the deformed edge-blend region and a block will now be described.

A shape of each block of the second image data before keystone correction is a uniform rectangular grid as shown in FIG. 6A but is deformed into a quadrilateral shape depicted by a grid of solid lines in the deformed image 101 as shown in FIGS. 6B and 6C. Each quadrilateral region in the deformed image 101 corresponding to each block of the second image data will be referred to as a deformed block.

In addition, the edge-blend region of the second image data before keystone correction is a rectangular region set along the right side of the image as represented by the hatched region in FIG. 6A. However, after the keystone correction, the edge-blend region of the second image data deforms into a quadrilateral region represented by the hatched region in the deformed image 101 as shown in FIGS. 6B and 6C. The quadrilateral region in the deformed image 101 corresponding to the edge-blend region of the second image data will be referred to as a deformed edge-blend region.

As shown in FIGS. 6B and 6C, the deformed blocks differ from the respective blocks of the third image data in both positions and shapes and no longer correspond to each of the plurality of light sources of the backlight unit 4. In addition, the deformed edge-blend region is no longer a region along an end section (a right side) of the image of the third image data.

There may be cases where a deformed block exists so as to straddle a plurality of blocks of the third image data. For example, an uppermost and rightmost block B1 in the second image data shown in FIG. 6A is deformed due to keystone correction into a deformed block A1 in the third image data shown in FIG. 6C. As shown in FIG. 6C, the deformed block A1 exists so as to straddle four blocks C1, C2, C3, and C4 of the third image data. The blocks C1, C2, C3, and C4 of the third image data are blocks corresponding to each light source of the backlight unit 4.

In the second image data shown in FIG. 6A, a region constituted by blocks (first blended blocks) where the edge-blend region exists is indicated by a solid dashed line. The first blended block includes blocks B1 (8, 1), B2 (8, 2), B3 (8, 3), B4 (8, 4), and B5 (8, 5).

In the third image data shown in FIG. 6C, a region constituted by deformed blocks (deformed blended blocks) corresponding to the respective blocks of the first blended block due to keystone correction are indicated by a solid dashed line. The deformed blended block includes deformed blocks A1 to A5. The deformed blended block contains a deformed edge-blend region.

In the third image data shown in FIG. 6C, a region constituted by blocks (second blended blocks) where the deformed blended blocks exist is indicated by a solid dashed line. The second blended block includes ten blocks (7, 1), (7, 2), (7, 3), (7, 4), (7, 5), (8, 1), (8, 2), (8, 3), (8, 4), and (8, 5). Moreover, the second blended block may be considered a block in which a deformed edge-blend region exists. In the first embodiment, as shown in FIG. 6C, blocks in which a deformed edge-blend region exists are the ten blocks (7, 1), (7, 2), (7, 3), (7, 4), (7, 5), (8, 1), (8, 2), (8, 3), (8, 4), and (8, 5).

<First Characteristic Value> (Original Image)

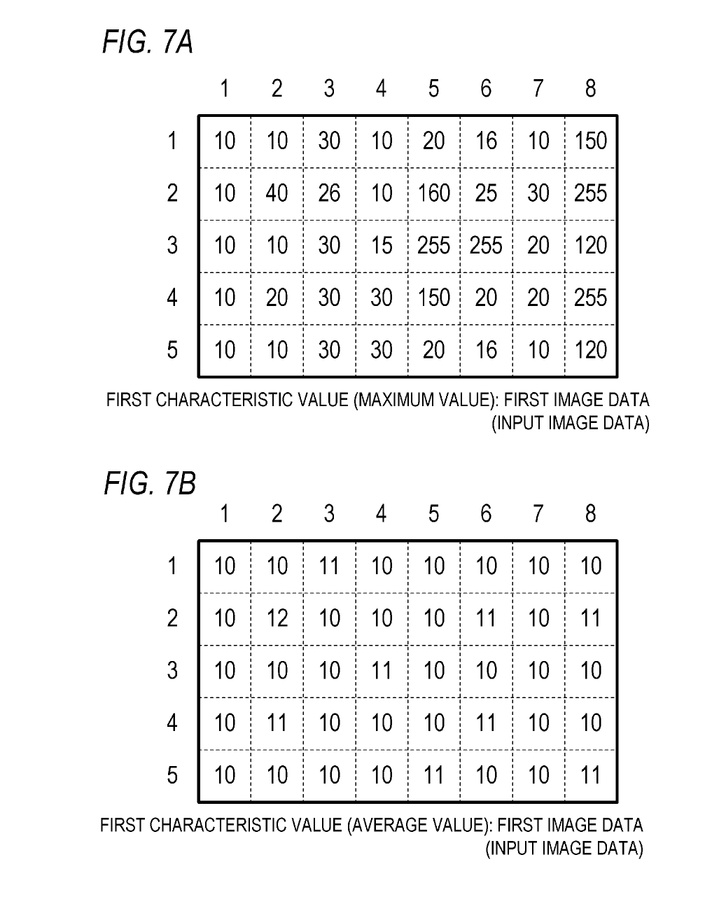

The first characteristic value acquiring unit 8 acquires a characteristic value of the first image data (a first characteristic value) for each block. The is image data is input image data to the projector 1. The first characteristic value acquiring unit 8 divides the first image data into eight horizontal five vertical blocks corresponding to the respective light sources of the backlight unit 4, and acquires the first characteristic value for each block. As the first characteristic value, the first characteristic value acquiring unit 8 acquires information on two types of values, namely, a maximum value of gradation values of pixels in a block and an average value of the gradation values of the pixels in the block. FIG. 7 shows an example of the first characteristic value. FIG. 7A shows a maximum value of gradation values of the respective blocks in the first image data, and FIG. 7B shows an average value of the gradation values of the respective blocks in the first image data In FIGS. 7A and 7B, numerals 1 to 8 in the horizontal direction and 1 to 5 in the vertical direction shown outside of the frames respectively represent horizontal and vertical coordinates of the blocks. The first characteristic value acquiring unit 8 outputs information on the first characteristic value to the characteristic value determining unit 10.

<Second Characteristic Value> (After Keystone Correction)

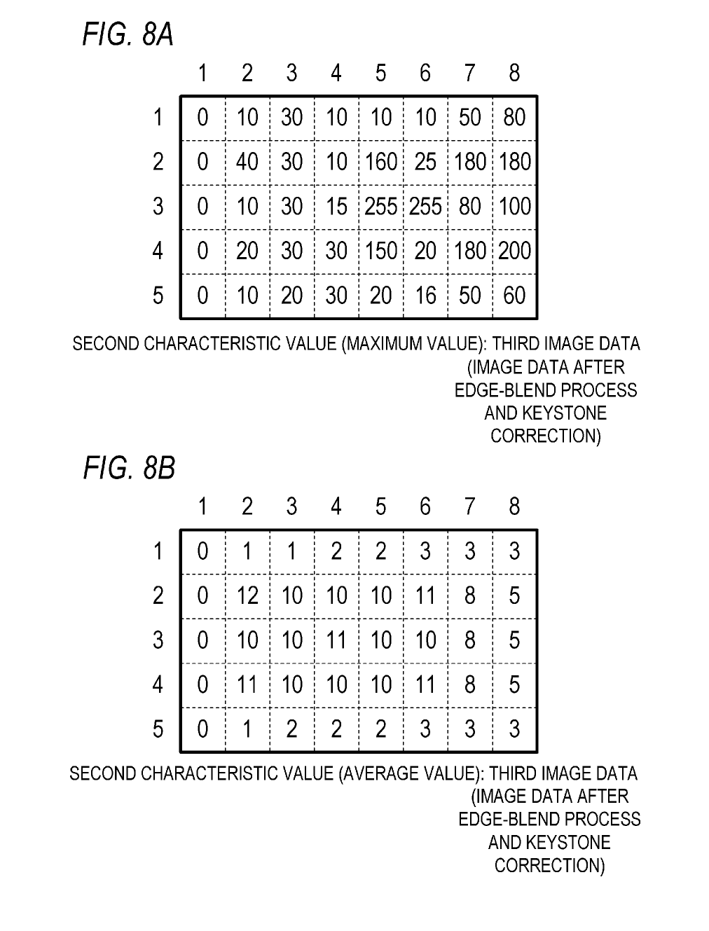

The second characteristic value acquiring unit 9 acquires a characteristic value of the third image data (a second characteristic value) for each block. As described above, the third image data is image data obtained by subjecting the first image data to an edge-blend process by the edge-blend processing unit 6 and to keystone correction by the keystone correction unit 7. The second characteristic value acquiring unit 9 divides the third image data into blocks corresponding to the respective light sources of the backlight, and acquires the second characteristic value for each block. As the second characteristic value, the second characteristic value acquiring unit 9 acquires information on two types of values, namely, a maximum value of gradation values of pixels in a block and an average value of the gradation values of the pixels in the block. FIG. 8 shows an example of the second characteristic value. FIG. 8A shows a maximum value of gradation values of the respective blocks in the third image data, and FIG. 8B shows an average value of the gradation values of the respective blocks in the third image data. In FIGS. 8A and 8B, numerals 1 to 8 in the horizontal direction and 1 to 5 in the vertical direction shown outside of the frames respectively represent horizontal and vertical coordinates of the blocks The second characteristic value acquiring unit 9 outputs information on the second characteristic value to the characteristic value determining unit 10.

<Third Characteristic Value> (Relationship with Projector 2)

The projector 1 controls emission amounts of the light sources of the projector 1 by also considering control information of the light sources of the projector 2 which projects a second projection image to be superimposed in the edge-blend region with a first projection image by the projector 1. Specifically, the projector 1 performs a process (first acquisition process) of acquiring the first characteristic value and the second characteristic value as described above from input image data. In addition, the projector 1 further performs a process (second acquisition process) of acquiring a third characteristic value that is reference information related to light source control of the backlight unit of the projector 2 from the projector 2. Based on the first characteristic value, the second characteristic value, and the third characteristic value of the projector 2 acquired as described above, the projector 1 obtains a fourth characteristic value that is basic information for determining an emission amount of each light source of the backlight unit 4. Furthermore, in order to enable the projector 2 to refer to control information of the light sources of the projector 1, the projector 1 obtains the third characteristic value that is reference information related to light source control of the projector 1 based on the first characteristic value and the second characteristic value, and transmits the third characteristic value to the projector 2.

Moreover, while each projector is configured so as to control an emission amount of a light source by also referring to control information of a light source of an adjacent projector in the first embodiment, the present invention is not limited to this configuration. Each projector may control an emission amount of a light source without referring to control information of a light source of another projector.

In addition, the first embodiment presents an example in which reference information related to light source control of the backlight unit of the projector 2 is acquired as information (third characteristic value) on a characteristic value of each block corresponding to each of a plurality of light sources (second light sources) included in the backlight unit (second light-emitting unit) of the projector 2. However, the present invention is not limited to this example as long as a format enabling reference to information related to light source control of the projector 2 is provided.

<Fourth Characteristic Value> (Basic Information for Control)

The characteristic value determining unit 10 acquires the following pieces of information and determines a fourth characteristic value based on the acquired information.
a) First characteristic value output from the first characteristic value acquiring unit 8
b) Second characteristic value output from the second characteristic value acquiring unit 9
c) Coordinates of the edge-blend region output from the edge-blend processing unit 6
d) Information related to keystone correction output from the keystone correction unit 7
e) Third characteristic value output from the projector 2
f) Blended block information output from the projector 2

In this case, blended block information refers to information indicating a position of a deformed edge-blend region in the third image data. Specifically, the blended block information is information on the second blended block described earlier.

The characteristic value determining unit 10 determines the third characteristic value based on the first characteristic value, the second characteristic value, the coordinates of the edge-blend region, and the information on keystone correction, and determines the fourth characteristic value based on the determined third characteristic value and the third characteristic value acquired from the projector 2. The characteristic value determining unit 10 outputs the determined fourth characteristic value to the emission amount determining unit 11. In addition, the characteristic value determining unit 10 obtains blended block information based on the coordinate information of the edge-blend region and the information on keystone correction. The characteristic value determining unit 10 outputs the third characteristic value of the projector 1 and the blended block information to the projector 2. Hereinafter, the respective functions of the characteristic value determining unit 10 will be described in detail.

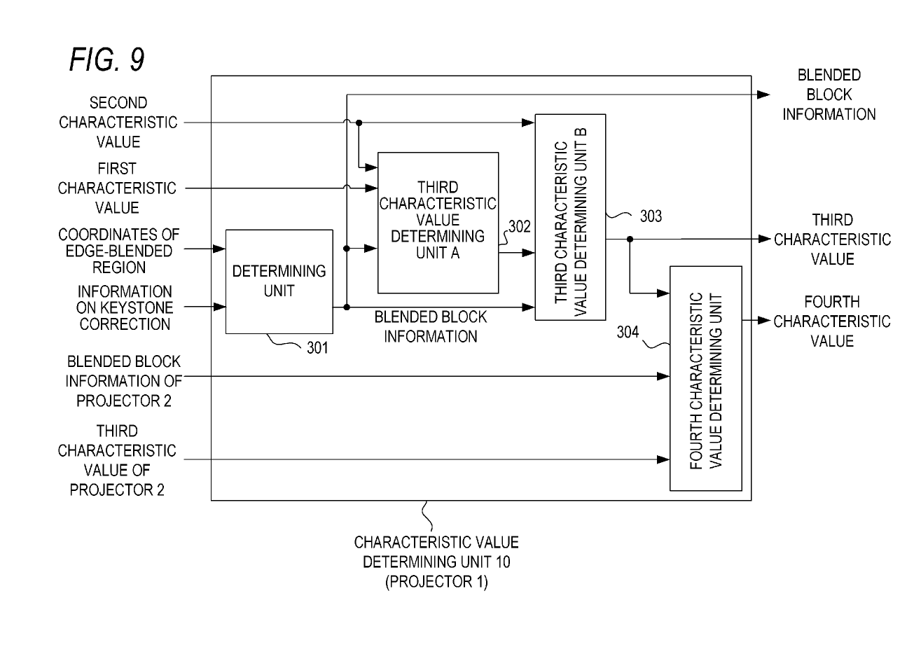

FIG. 9 is a diagram showing a configuration of the characteristic value determining unit 10. The characteristic value determining unit 10 includes a determining unit 301, a third characteristic value determining unit A 302, a third characteristic value determining unit B 303, and a fourth characteristic value determining unit 304.

The determining unit 301 determines a block (second blended block) in which a deformed edge-blend region exists in the third image data and outputs a determination result as blended block information.

The third characteristic value determining unit A 302 determines a third characteristic value of the second blended block based on the first characteristic value, the second characteristic value, and the blended block information.

The third characteristic value determining unit B 303 determines a third characteristic value of blocks other than the second blended block based on the second characteristic value. In addition, the third characteristic value determining unit B 303 combines the third characteristic value with the characteristic value of the second blended block as determined by the third characteristic value determining unit A 302 thereby determining a third characteristic value of all blocks in the third image data.

The fourth characteristic value determining unit 304 determines a fourth characteristic value of the projector 1 based on the third characteristic value of the projector 1 determined by the third characteristic value determining unit B 303 and the third characteristic value of the projector 2 acquired from the projector 2. Hereinafter, details of the respective functions will be described.

The determining unit 301 obtains a first blended block, a deformed blended block, and a second blended block based on the information on the edge-blend region, information on the keystone correction, and information on the blocks, and outputs the information on the second blended block.

In the example shown in FIGS. 6A and 6C, the first blended blocks are the blocks B1 to B5 and the deformed blended blocks are the deformed blocks A1 to A5. The second blended blocks are the ten blocks (7, 1), (7, 2), (7, 3), (7, 4), (7, 5), (8, 1), (8, 2), (8, 3), (8, 4), and (8, 5) arranged in two columns along the right side.

The determining unit 301 outputs the blended block information to the third characteristic value determining unit A 302 and the third characteristic value determining unit B 303. In addition, the determining unit 301 outputs the blended block information to the communicating unit 15 to be transmitted to the projector 2.

<Third Characteristic Value> (Details)

The third characteristic value determining unit A 302 determines the third characteristic value of the second blended block based on the first characteristic value, the second characteristic value, and the blended block information. Hereinafter, the third characteristic value of the second blended block will be described.

When the edge-blend process is performed, since brightness (a gradation value of pixels) of an image in the edge-blend region changes, a characteristic value (a maximum value and an average value of gradation values) of the edge-blend region also changes. In addition, when keystone correction is performed, since a position and a shape of the edge-blend region changes, a characteristic value of a block corresponding to each light source also changes. Therefore, light source control such as dark part priority processing performed based on a characteristic value related to the brightness of an image is favorably performed based on the brightness of an original image prior to the edge-blend process. In consideration thereof, in the first embodiment, the third characteristic value determining unit A 302 basically determines the third characteristic value of the second blended block based on a characteristic value (the first characteristic value) of image data prior to the edge-blend process as acquired by the first characteristic value acquiring unit 8. Hereinafter, a determination method of the third characteristic value in several cases will be specifically described.

(Pattern 1)

A case where a block (an object block) corresponding to a light source that is an object of determination of an emission amount is a block C2 (8, 1) shown in FIG. 6C will now be described. The block C2 is a second blended block including pixels of a deformed blended block and, specifically, includes a part of the pixels of a deformed block A1 in the deformed blended block. The block C2 also includes dummy data (black pixels) added by keystone correction. A block of the first image data prior to deformation which corresponds to the deformed block A1 is B1 (8, 1).

In this manner, when there is only one block (B1) in the first image data to which a pixel of a deformed blended region deformed superimposition region) included in the object block (C2) had belonged prior to deformation, the third characteristic value determining unit A 302 determines the third characteristic value as follows. The third characteristic value determining unit A 302 determines the third characteristic value of the object block (C2) based on the first characteristic value of the block (B1) in the first image data corresponding to the deformed blended block (A1) included in the object block (C2).

In this case, the third characteristic value determining unit A 302 determines the third characteristic value of the object block C2 based on the first characteristic value of the block B1 prior to deformation corresponding to the deformed block A1 included in the block C2 From FIGS. 7A and 7B, the first characteristic value of the block B1 is a maximum value of 150 and an average value of 10. Therefore, the third characteristic value determining unit A 302 determines a maximum value of 150 and an average value of 10 as the third characteristic value of the block C2.

(Pattern 2)

A case where a block (an object block) corresponding to a light source that is an object of determination of an emission amount is a block C4 (8, 2) shown in FIG. 6C will now be described. The block C4 is a second blended block including pixels of a deformed blended block and, specifically, includes a part of the pixels of deformed blocks A1 and A2 in the deformed blended block. The block C4 also includes black pixels added by keystone correction. Blocks prior to deformation which correspond to the deformed blocks A1 and A2 are B1 (8, 1) and B2 (8, 2).

In this manner, when a plurality of pixels of a deformed blended region (a deformed superimposition region) included in the object block (C4) had belonged to mutually different blocks (B1 and B2) in the first image data prior to deformation, the third characteristic value determining unit A 302 determines the third characteristic value as follows. The third characteristic value determining unit A 302 determines the third characteristic value of the object block (C4) based on the first characteristic value of each of the different blocks (B1 and B2) in the first image data corresponding to the deformed blocks (A1 and A2) included in the object block (C4).

In the first embodiment, the projector determines an emission amount of a light source based on a prescribed correspondence between a characteristic value of image data and an emission amount of a light source. Specifically, the emission amount determining unit 11 determines an emission amount of a light source based on a maximum value in a third characteristic value of an object block. Therefore, when the third characteristic value is determined based on a smaller value among first characteristic values (maximum values) of a plurality of different blocks corresponding to an object block, there is a possibility that display brightness assumed by original image data cannot be reproduced even when image processing (a gradation expansion process) is performed by the image correcting unit 14. In consideration thereof, in the first embodiment, in order to prioritize reproducibility of display brightness, in the first characteristic values (maximum values and average values) of a plurality of different blocks corresponding to an object block, a value with a larger corresponding emission amount in the correspondence is to be adopted as the third characteristic value of the object block.

In the example described above, the third characteristic value determining unit A 302 determines the third characteristic value of the object block C4 based on whichever is the larger of values of the respective first characteristic values of the blocks B1 and B2 prior to deformation corresponding to the deformed blocks A1 and A2 included in the block C4. From FIGS. 7A and 7B, the first characteristic value of the block B1 is a maximum value of 150 and an average value of 10 and the first characteristic value of the block B2 is a maximum value of 255 and an average value of 11. Therefore, the third characteristic value determining unit A 302 determines a maximum value of 255 and an average value of 11 as the third characteristic value of the block C4.

(Pattern 3)

A case where a block (an object block) corresponding to a light source that is an object of determination of an emission amount is a block C1 (7, 1) shown in FIG. 6C will now be described. The block C1 is a second blended block including pixels of a deformed blended block and, specifically, includes a part of the pixels of a deformed block A1 in the deformed blended block. The block C1 also includes pixels other than the deformed blended block in the third image data as well as black pixels added by keystone correction. The pixels other than the deformed blended block in the third image data belong to the block C1 in the third image data A block of the first image data prior to deformation which corresponds to the deformed block A1 is B1 (8, 1).

In this manner, when pixels of a deformed blended region (a deformed superimposition region) and pixels outside of the deformed blended region (outside of the deformed superimposition region) belong to the object block (C1), the third characteristic value determining unit A 302 determines the third characteristic value as follows. The third characteristic value determining unit A 302 determines the third characteristic value of the object block (C1) based on the first characteristic value of the block (B1) corresponding to the deformed blended block (A1) included in the object block (C1) and on the second characteristic value of the block (C1) in the third image data.

In the first embodiment, the projector 1 determines an emission amount of a light source based on a prescribed correspondence between a characteristic value of image data and an emission amount of a light source. As described above, the third characteristic value determining unit A 302 basically determines the third characteristic value of the second blended block based on the first characteristic value of a block corresponding to a deformed block including a deformed edge-blend region. However, as in the example of the block C1, when an emission amount of a block to which pixels of a deformed block (A6) not including the deformed edge blend region also belong is determined based solely on the first characteristic value of the block (B1), there is a possibility that brightness of the deformed block A6 cannot be reproduced. Therefore, in the first embodiment, in consideration of reproducibility of display brightness, the first characteristic value of a block corresponding to a deformed block including the deformed edge-blend region and the second characteristic value acquired by the second characteristic value acquiring unit 9 with respect to the object block (C1) are compared with each other. In addition, a value with a larger corresponding emission amount in the correspondence is to be adopted as the third characteristic value of the object block.

In the example described above, the third characteristic value determining unit A 302 determines the third characteristic value of the object block C1 based on whichever is the larger of values of the first characteristic value of the block B1 prior to deformation corresponding to the deformed block A1 included in the block C1 and the second characteristic value of the block C1 The first characteristic value of the block B1 is a maximum value of 150 and an average value of 10 and, from FIGS. 8A and 8B, the second characteristic value of the block C1 is a maximum value of 50 and an average value of 3. Therefore, the third characteristic value determining unit A 302 determines a maximum value of 150 and an average value of 10 as the third characteristic value of the block C1.

(Pattern 4)

A case where a block (an object block) corresponding to a light source that is an object of determination of an emission amount is a block C5 (6, 1) shown in FIG. 6C will now be described. The block C5 does not, include pixels of a deformed blended region. In this manner, when pixels of a deformed blended region (a deformed superimposition region) are not included in the object block, the third characteristic value determining unit A 302 determines the third characteristic value of the object block (C5) based on the second characteristic value of the object block (C5). From FIGS. 8A and 8B, the second characteristic value of the block C5 is a maximum value of 10 and an average value of 3. Therefore, the third characteristic value determining unit A 302 determines a maximum value of 10 and an average value of 3 as the third characteristic value of the block C5.

<Third Characteristic Value>

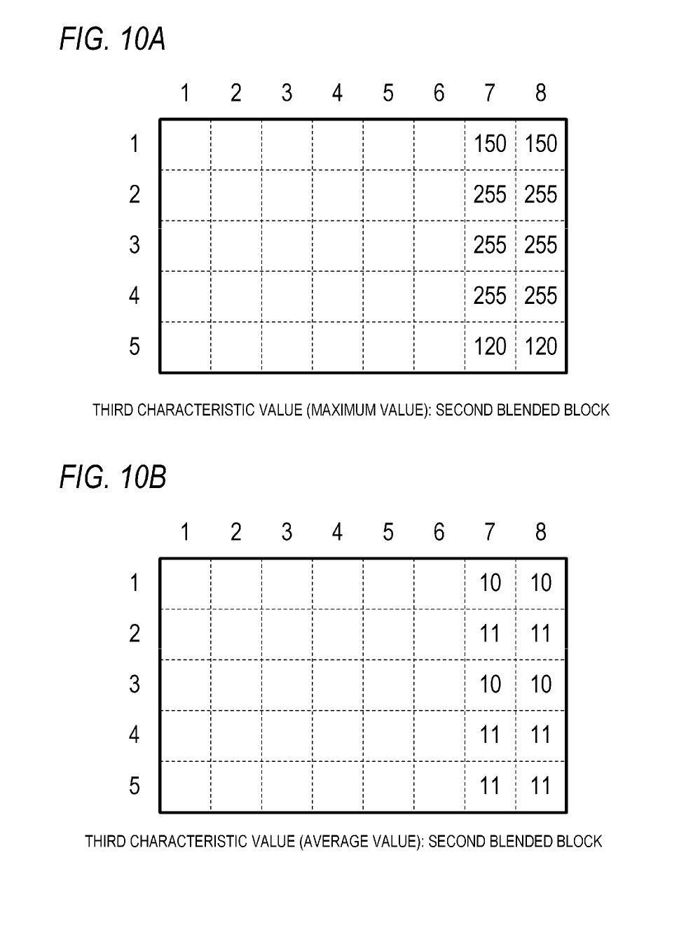

The third characteristic value (maximum value) of the second blended block as determined by the third characteristic value determining unit A 302 is shown in FIG. 10A. The third characteristic value (average value) of the second blended block is shown in FIG. 10B. The third characteristic value determining unit A 302 outputs information on the determined third characteristic value to the third characteristic value determining unit B 303.

The third characteristic value determining unit B 303 determines the third characteristic value of all blocks based on the second characteristic value acquired from the second characteristic value acquiring unit 9, the third characteristic value of the second blended block acquired from the third characteristic value determining unit A 302, and the blended block information. With respect to the second blended block, the third characteristic value determining unit B 303 uses the third characteristic value (FIGS. 10A and 10B) determined by the third characteristic value determining unit A 302 without modification. In addition, with respect to blocks other than the second blended block, the third characteristic value determining unit B 303 adopts the second characteristic value (FIGS. 8A and 8B) of the blocks as the third characteristic value of the blocks.

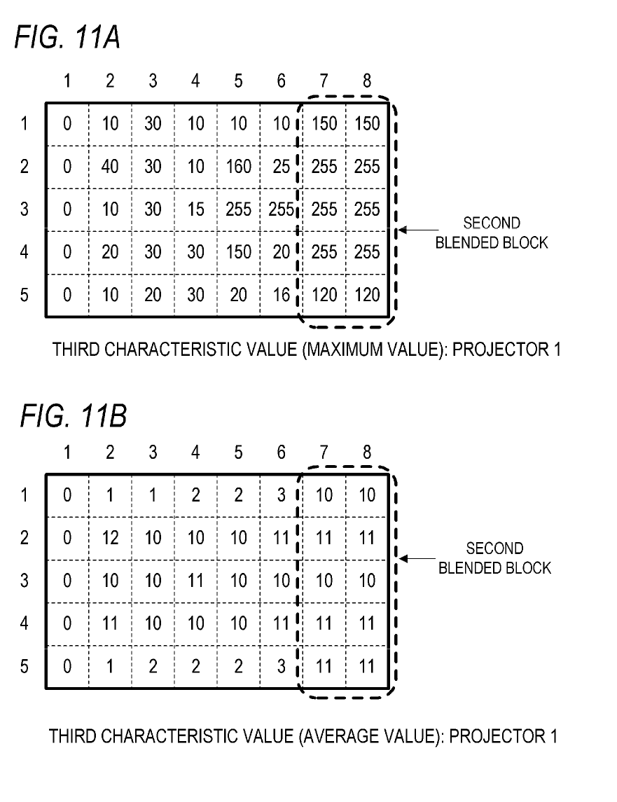

The third characteristic value determined by the third characteristic value determining unit B 303 is shown in FIGS. 11A and 11B. The third characteristic value determining unit B 303 outputs information on the third characteristic value to the fourth characteristic value determining unit 304 and to the communicating unit 15 to be transmitted to the projector 2.

<Fourth Characteristic Value>

The fourth characteristic value determining unit 304 determines a fourth characteristic value based on the third characteristic value determined by the third characteristic value determining unit B 303 and the third characteristic value and the blended block information of the projector 2 acquired from the projector 2. The fourth characteristic value determining unit 304 compares, for each block, the third characteristic value of the second blended block of the projector 1 and the third characteristic value of the second blended block of the projector 2 with each other, and determines a larger value as the fourth characteristic value.

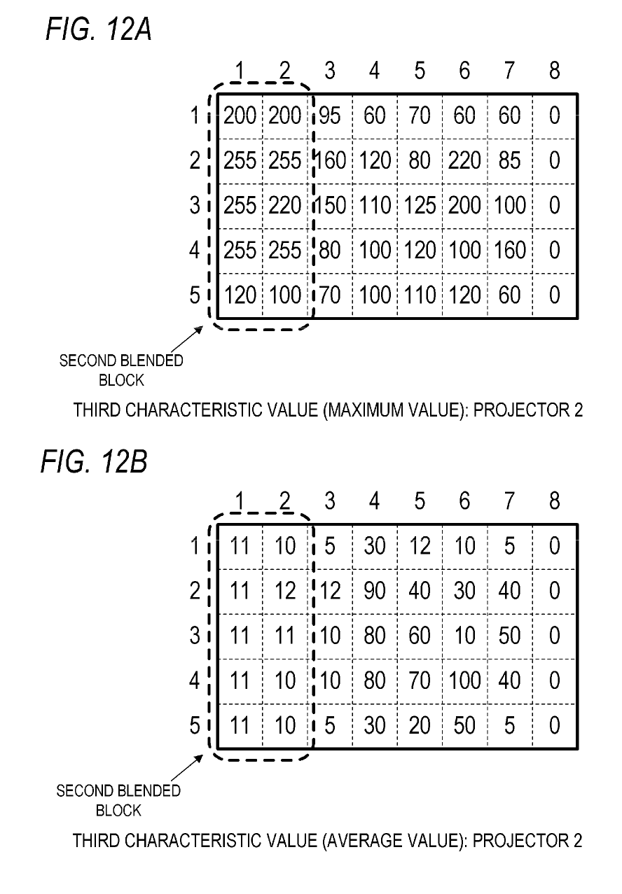

FIG. 12 is a diagram showing an example of a third characteristic value of the projector 2. FIG. 12A shows the third characteristic value (maximum value) of the projector 2 and FIG. 12B shows the third characteristic value (average value) of the projector 2. Numerals 1 to 8 in the horizontal direction and 1 to 5 in the vertical direction outside the frames shown in FIGS. 12A and 12B respectively represent horizontal and vertical coordinates of the blocks. Blended block information of the projector 2 includes information indicating that coordinates of the second blended blocks of the projector 2 are (1, 1), (1, 2), (1, 3), (1, 4), (1, 5), (2, 1), (2, 2), (2, 3), (2, 4), and (2, 5). In the first embodiment, it is assumed that the number of block divisions and block sizes of the projector 1 and the projector 2 are the same in both the horizontal direction and the vertical direction, and that the numbers and sizes of the second blended blocks are also the same. The fourth characteristic value determining unit 304 superimposes the second blended blocks of the projector 1 and the second blended blocks of the projector 2 on each other and compares third characteristic values between blocks at a same position. For example, the fourth characteristic value determining, unit 304 compares third characteristic values between a block (7, 1) of the projector 1 and a block (1, 1) of the projector 2.

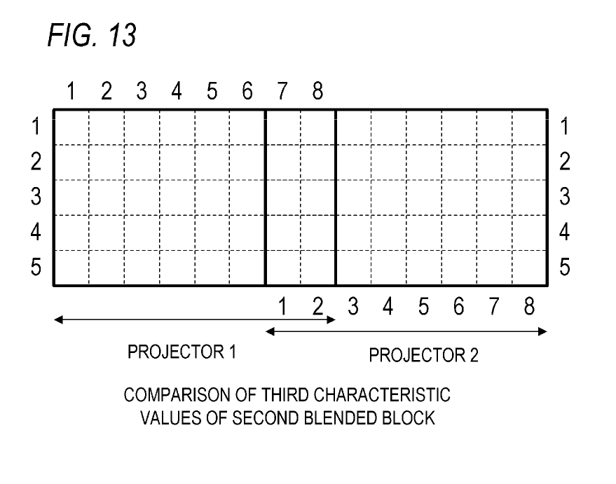

A conceptual diagram of superimposition is shown in FIG. 13. The diagram shows that the block (7, 1) of the projector 1 and the block (1, 1) of the projector 2 are at the same position. The diagram also shows that the block (8, 1) of the projector 1 and the block (2, 1) of the projector 2 are at the same position. The fourth characteristic value determining unit 304 determines blocks that are comparison objects by superimposing second blended blocks of the projector 1 and the projector 2 as described above.

The fourth characteristic value determining unit 304 compares maximum values) of the respective second blended blocks in FIGS. 11A and 12A, and determines a larger value as the fourth characteristic value (maximum value).

The fourth characteristic value determining unit 304 compares average values of the respective second blended blocks in FIGS. 11B and 12B, and determines a larger value as the fourth characteristic value (average value).

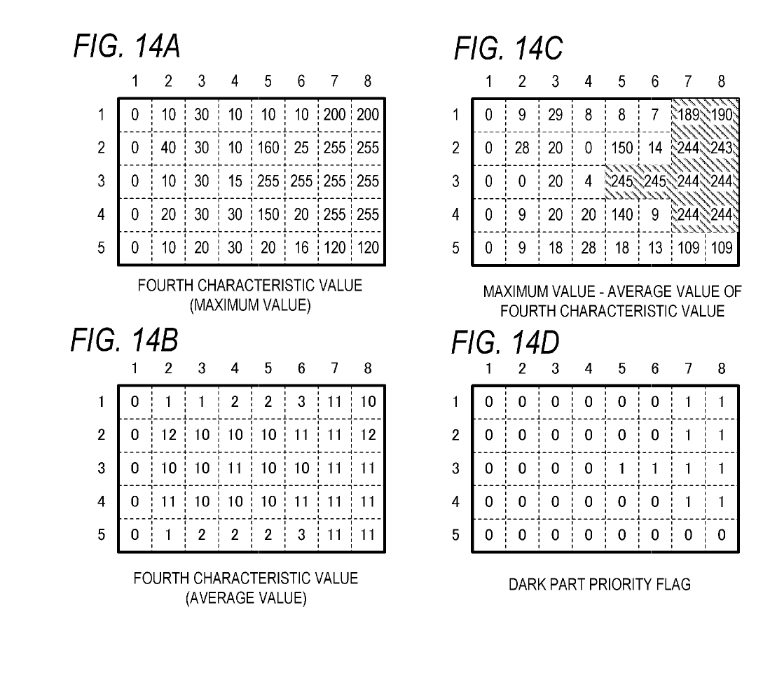

The fourth characteristic values of the projector 1 determined in this manner are shown in FIGS. 14A and 14B.

The characteristic value determining unit 10 outputs information on the fourth characteristic values determined by the fourth characteristic value determining unit 304 to the emission amount determining unit 11.

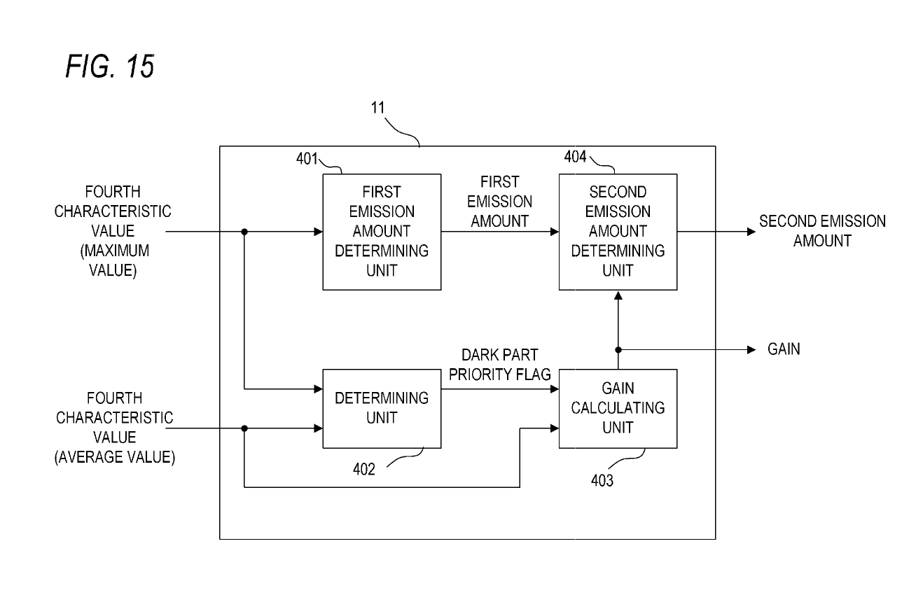

The emission amount determining unit 11 determines an emission amount of each light source of the backlight unit 4 based on the fourth characteristic values determined by the characteristic value determining unit 10. The emission amount determining unit 11 determines the emission amount based on a maximum value among the fourth characteristic values. Moreover, the emission amount determining unit 11 determines whether or not to consider a block as an object block of dark part priority processing (to be described later) based on a maximum value and an average value among the fourth characteristic values. A detailed functional configuration of the emission amount determining unit 11 is shown in FIG. 15.

The emission amount determining unit 11 is constituted by a first emission amount determining unit 401, a determining unit 402, a gain calculating unit 403, and a second emission amount determining unit 404.

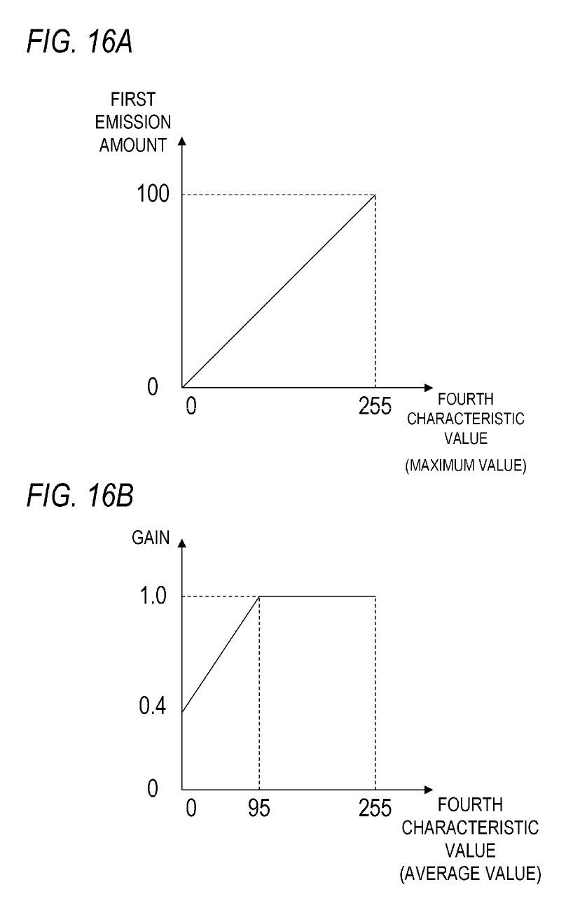

The first emission amount determining unit 401 obtains a first emission amount from the maximum value among the fourth characteristic values and outputs the first emission amount to the second emission amount determining unit 404. The first emission amount determining unit 401 stores information on a relationship between a maximum value among the fourth characteristic values and a first emission amount of the backlight such as that shown in FIG. 16A in, for example, a lookup table format. The first emission amount determining unit 401 reads and determines a value of the first emission amount corresponding to the maximum value of the fourth characteristic values from the lookup table. A horizontal axis in FIG. 16A represents the fourth characteristic value (a maximum value) and a vertical axis represents the first emission amount. The first emission amount is an emission control value of a light source of the backlight. When the first emission amount is 0, the light source is controlled so as not to be lighted, and when the first emission amount is 100, the light source is controlled so as to be lighted at maximum brightness.

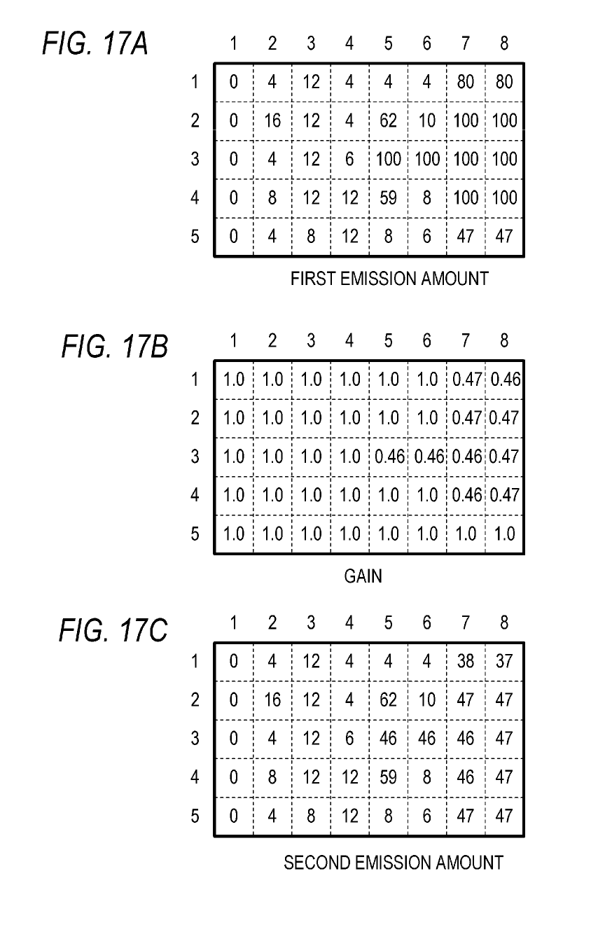

When the fourth characteristic value (maximum value) is as shown in FIG. 14A, the first emission amount of each of the blocks of the projector 1 as determined based on the relationship shown in FIG. 16A is as shown in FIG. 17A. Moreover, a method of determining the first emission amount from the fourth characteristic value is not limited to a method using the lookup table described above and may be a calculation method using a calculation formula.

The determining unit 402 determines whether or not each block is to be considered an object of dark part priority processing based on the maximum value and the average value of the fourth characteristic values. In the first embodiment, the determining unit 402 determines a block satisfying

average value of fourth characteristic values≧20, and

(maximum value of fourth characteristic values−average value of characteristic values)≧160

as an object of the dark part priority processing. A small average value indicates that an image of the block is an image mainly showing a dark background and a large difference between the maximum value and the average value indicates that a high-brightness object exists within the block. A block satisfying the conditions described above can be determined as an image in which a high-brightness object with a small area is present against a dark background. In the first embodiment, an emission amount of a light source corresponding to such a block controlled so as to preferentially enable an occurrence of a halo or black floating to be suppressed over reproducibility of display brightness of the high-brightness object.

FIG. 14C is a diagram indicating a difference between a maximum value and an average value of the fourth characteristic values as calculated from FIGS. 14A and 14B. FIG. 14B shows that all of the blocks satisfy the condition with respect to the average value of the fourth characteristic values. FIG. 14C shows that the blocks (5, 3), (6, 3) (7, 1), (7, 2), (7, 3), (7, 4), (8, 1), (8, 2), (8, 3), and (8, 4) satisfy the condition with respect to the difference between the maximum value and the average value of the fourth characteristic values. Therefore, the hatched blocks in FIG. 14C are determined as object blocks of the dark part priority processing The determining unit 402 sets a dark part priority flag to 1 for blocks determined as objects of the dark part priority processing as described above and outputs flag information to the gain calculating unit 403. FIG. 14D shows a dark part priority flag for each block.

The gain calculating unit 403 calculates a gain for adjusting the first emission amount for blocks of which the dark part priority flag is 1 and outputs the gain to the second emission amount determining unit 404. In addition, the gain calculating unit 403 outputs the gain to the second coefficient determining unit 13. The second emission amount determining unit 404 stores information on a relationship between an average value among the fourth characteristic values and a gain such as that shown in FIG. 16B in, for example, a lookup table format. The second emission amount determining unit 404 reads and determines a value of the second emission amount corresponding to the average value of the fourth characteristic values from the lookup table. A horizontal axis in FIG. 16B represents the fourth characteristic value (average value) and a vertical axis represents gain. When the gain is 1.0, a value of the first emission amount is not changed by an adjustment.

With respect to blocks of which the dark part priority flag is 0, the gain calculating unit 403 sets the gain to 1 regardless of the average value of the fourth characteristic values. With respect to blocks of which the dark part priority flag is 1, the gain calculating unit 403 calculates a gain in accordance with the average value of the fourth characteristic values with reference to the lookup table. FIG. 17B shows gains obtained based on FIGS. 14A and 14D. The gain calculating unit 403 outputs the obtained gains to the second emission amount determining unit 404 and the second coefficient determining unit 13.

The second emission amount determining unit 404 multiplies the first emission amount determined by the first emission amount determining unit 401 with the gain calculated by the gain calculating unit 403 to determine a second emission amount. When kBL denotes the first emission amount and adGain denotes gain, the second emission amount BL may be obtained by

BL=adGain×kBL.

The second emission amount determined in this manner is shown in FIG. 17C.

The emission amount determining unit 11 outputs the second emission amount to the brightness estimating unit 12 and the backlight unit 4. Eventually, light emission by each light source of the backlight unit 4 is to be controlled based on the second emission amount. As is apparent from FIG. 17C, the second emission amount of a light source corresponding to each block has a smaller value than a maximum emission amount of 100. This means that local dimming control in which the backlight is lighted darkly in a localized manner in accordance with brightness of a display image is to be performed. Accordingly, display contrast can be improved and power consumption can be reduced. When the dark part priority processing is not performed, the first emission amount may be adopted as a final emission control value.

The brightness estimating unit 12 estimates brightness of light incident to the liquid crystal panel unit 5 when each light source of the backlight unit 4 is subjected to light emission control based on the second emission amount. The brightness estimating unit 12 estimates brightness at a center position of each block. When the light source of the backlight unit 4 corresponding to a given block emits light, the light emitted from the light source is diffused to peripheral blocks. The brightness estimating unit 12 stores, in a memory, information on intensity of diffused light (information on an attenuation rate) at an estimation position of each peripheral block when a given light source emits light in a reference emission amount as an attenuation coefficient associated with each block. The brightness estimating unit 12 calculates an estimated value of brightness at the center position of each block by multiplying the second emission amounts determined by the emission amount determining unit 11 with the attenuation coefficient read from the memory and adding up all multiplication results.

The brightness estimating unit 12 calculates an estimated value of brightness at the center position of blocks that are objects of brightness estimation by summing up products of the attenuation coefficient at the center position of a block that is an object of brightness estimation and the second emission amounts determined by the emission amount determining unit 11 for all of the 40 blocks. The brightness estimating unit 12 calculates an estimated value of brightness at the center position for each of the 40 blocks. The brightness estimating unit 12 outputs an estimation result to the second coefficient determining unit 13.

While an example of estimating brightness at a center position of a block has been described in the first embodiment, a position at which brightness is estimated need not be a center position or brightness may be estimated at two or more positions. Obtaining an estimated value of brightness at a larger number of positions enables a brightness distribution of light incident to the liquid crystal panel unit 5 to be obtained in greater detail. The number and positions of estimation points may be determined in accordance with an accuracy required for reproducibility of display brightness by image correction performed by the image correcting unit 14.

The second coefficient determining unit 13 obtains a correction coefficient of image data based on the estimated value of brightness calculated by the brightness estimating unit 12. The projector 1 according to the first embodiment expands a gradation value of image data based on an estimated value of brightness in order to compensate, by image processing, for a decline in display brightness corresponding to a localized reduction in brightness of a light source of the backlight unit 4 due to local dimming control. The correction coefficient is a coefficient for this expansion process. With respect to positions where the estimated brightness exceeds a target brightness assumed by original image data, the second coefficient determining unit 13 calculates the correction coefficient so as to lower the brightness. When Lpn denotes an estimated brightness value and Lt denotes target brightness at a point that is an object of calculation of the correction coefficient, a correction coefficient Gpn can be obtained by

Gpn=Lt/Lpn.

Moreover, the target brightness Lt is determined based on a maximum value of target brightness in a block to which a point corresponding to the estimated brightness value belongs. In addition, when the block to which a point corresponding to the estimated brightness value belongs is an object block of the dark part priority processing, the target brightness is lowered by multiplying the gain determined by the emission amount determining unit 11. When adGain denotes gain, the correction coefficient Gpn can be obtained by

Gpn=adGain×Lt/Lpn.

The second coefficient determining unit 13 outputs the correction coefficient of each point calculated as described above to the image correcting unit 14. Moreover, the correction coefficient obtained by the method described above is a correction coefficient applied to a pixel at a center point of each block and is spatially discrete. The second coefficient determining unit 13 obtains a correction coefficient to be applied to a pixel at a position other than the point for which the correction coefficient has been calculated by an interpolation calculation based on correction coefficients at center points of peripheral blocks of the other position.

The image correcting unit 14 corrects image data by multiplying each pixel value in the image data with the correction coefficient determined by the second coefficient determining unit 13. The image correcting unit 14 outputs the corrected image data to the liquid crystal panel unit 5.

The communicating unit 15 is connected to a communicating unit of the projector 2 and receives the third characteristic value and the blended block information of the projector 2 from the projector 2. The communicating unit 15 is, for example, a local area network (LAN) or a universal serial bus (USB). The communicating unit 15 is connected to the characteristic value determining unit 10 and transmits the third characteristic value and the blended block information of the projector 1 to the projector 2.

The projector 2 has similar functions to the projector 1.

In the multi-projection system according to the first embodiment described above, a projector performs an edge-blend process and keystone correction on input image data. An emission amount of a light source corresponding to a block including pixels of an edge-blend region is controlled based on first image data prior to the edge-blend process instead of second image data after the edge-blend process. Accordingly, the emission amount of the light source can be controlled based on original image data before brightness is adjusted by the edge-blend process. Therefore, for example, whether or not a block is to be considered an object of dark part priority processing for controlling a halo phenomenon can be determined correctly.

In addition, in the first embodiment, when the edge-blend region has been deformed by the keystone correction, an emission amount of a light source at a position corresponding to the deformed edge-blend region in third image data after the keystone correction is controlled based on the first image data prior to the edge-blend process.

Each projector acquires, for each block corresponding to each of a plurality of light sources of a backlight, a characteristic value of input image data (an original image) and a characteristic value of image data after the edge-blend process and the keystone correction are performed on the input image data. In the edge-blend process, brightness adjustment is performed on the edge-blend region. Each projector identifies a position of the edge-blend region in image data after the keystone correction. In the first embodiment, the image data after the keystone correction is divided into a plurality of blocks respectively corresponding to a plurality of light sources, and a block in which the edge-blend region deformed by the keystone correction (a deformed edge-blend region) is identified.

Each projector determines an emission amount of a light source corresponding to a block in which the deformed edge-blend region exists based on a characteristic value of input image data. On the other hand, each projector determines an emission amount of a light source corresponding to a block in which the deformed edge-blend region does not exist based on a characteristic value of image data after being subjected to the edge-blend process and the keystone correction. Accordingly, the emission amount of a light source corresponding to the deformed edge-blend region can be determined based on the characteristic value of image data before brightness is changed by the edge-blend process. Therefore, for example, since whether or not an image includes a high-brightness object with a small area against a dark background can be determined based on an original image, adjustment of an emission amount for suppressing a halo phenomenon can be accurately performed. As a result, image quality of a projection image can be improved

According to the multi-projection system constituted by the projector 1 and the projector 2 described above, even when an edge-blend process, keystone correction, and local dimming are performed, display brightness assumed by original image data can be reproduced. In addition, a block to be an object of dark part priority processing can be appropriately determined and an improvement in image quality of a projection image which suppresses a halo phenomenon and black floating and improves contrast can be achieved

### Second Embodiment

In the first embodiment, an example has been described in which settings of image processing based on optical necessities such as an edge-blend process and keystone correction are the same between projectors and the number and sizes of blocks corresponding to a plurality of light sources of a backlight are also the same. In a second embodiment, a case where the number and sizes of blocks corresponding to a plurality of light sources of a backlight differ among projectors constituting a multi-projection system will be described.

In the second embodiment, since block configurations differ among a plurality of adjacent projectors which project projection images, when comparing characteristic values of blocks where a deformed edge-blend region exists between projectors, a block that is a comparison object cannot be simply identified as in the first embodiment. In the second embodiment, a correspondence between blocks to be compared is determined based on setting values of optical correction processes such as an edge-blend process and keystone correction and on information related to block configurations. Accordingly, a comparison between projectors of characteristic values of blocks where a deformed edge-blend region exists can be appropriately performed and a similar advantageous effect to the first embodiment can be produced even when block configurations differ between projectors.

When blended block information received by a projector according to the second embodiment from another projector indicates a block size which differs from a size of a block of the projector, the projector corrects the blended block information of the other projector in compliance with its own block size. Specifically, the projector determines a correspondence between each of the blocks in which the deformed edge-blend region exists of another projector and blocks in which the deformed edge-blend region exists in the projector, and compares characteristic values. Hereinafter, details of the second embodiment will be described.

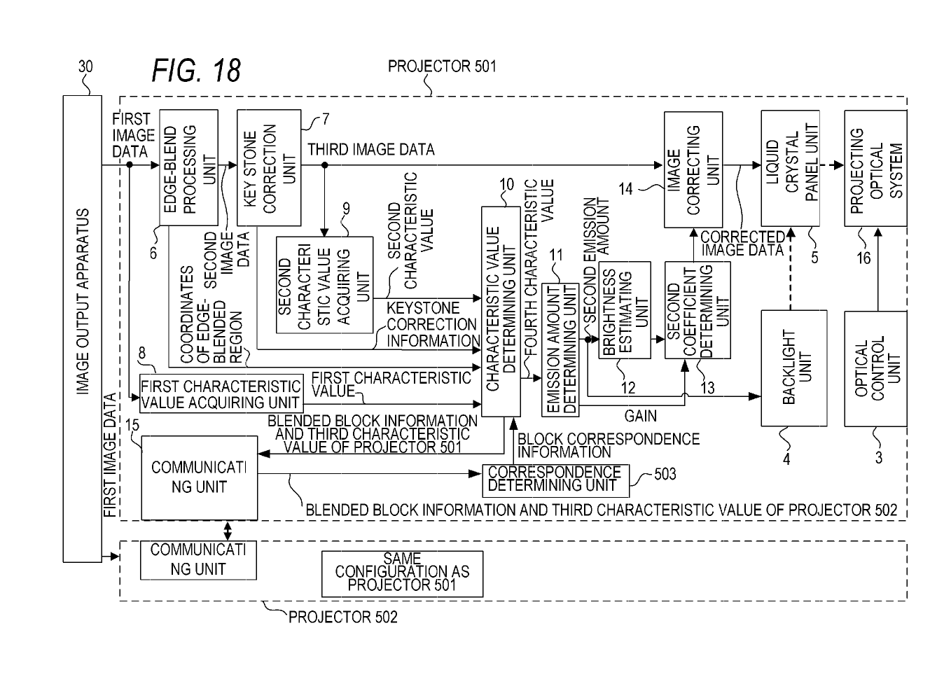

FIG. 18 is a diagram showing a functional configuration of the multi-projection system according to the second embodiment. A projector 501 and a projector 502 according to the second embodiment are constituted by approximately the same functions. However, coordinates of an edge-blend region, information on keystone correction, and sizes of blocks corresponding to each light source of a backlight differ from each other. With the exception of a correspondence determining unit 503, the projector 501 is constituted by approximately the same functions as the projector 1 according to the firs t embodiment. Hereinafter, differences from the functions described in the first embodiment will be mainly described.

When sizes of blocks (second blended blocks) in which the deformed edge-blend region exists differ between the projectors, the correspondence determining unit 503 determines a correspondence between the second blended block of the projector 501 and the second blended block of the projector 502. As a result, the fourth characteristic value determining unit 304 of the characteristic value determining unit 10 is now able to compare the third characteristic value of the second blended block of the projector 501 and the third characteristic value of the second blended block of the projector 502 with each other. The correspondence determining unit 503 outputs information of the determined correspondence to the characteristic value determining unit 10 as block correspondence information.

The correspondence determining unit 503 compares a size of the second blended block of the projector 502 (transmitting side) and a size of the second blended block of the projector 501 (receiving side) with each other. The comparison is performed by enlarging an area of the second blended block with a smaller size so as to equal, an area of the second blended block with a larger size. On this basis, the correspondence determining unit 503 determines the correspondence between the second blended block of the projector 502 and the second blended block of the projector 501. A detailed description will now be given with reference to FIG. 18.

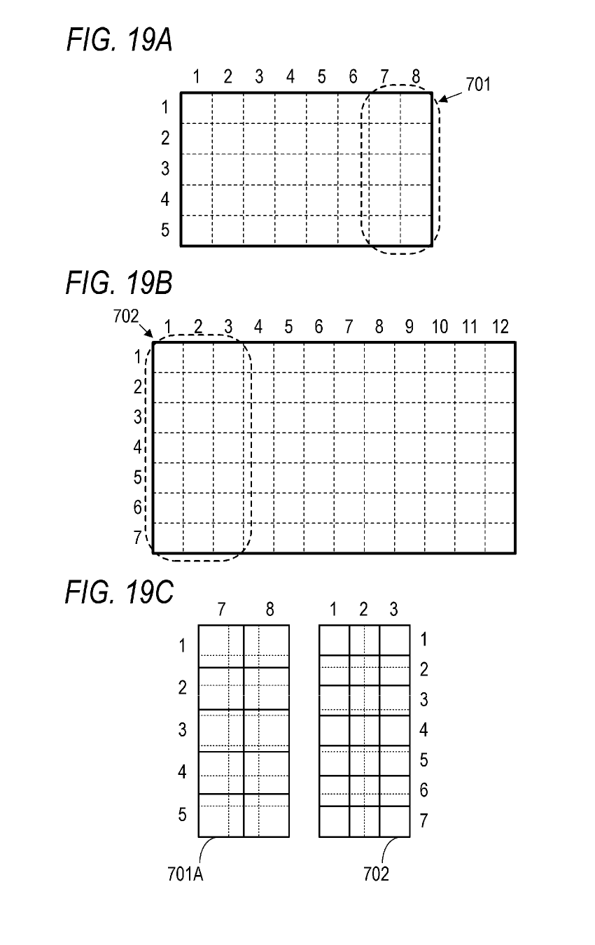

FIG. 19A shows a block configuration of the third characteristic value of the projector 501, and FIG. 19B shows a block configuration of the third characteristic value of the projector 502 as received by the projector 501. It is assumed that the block configuration of the projector 501 includes eight blocks in the horizontal direction and five blocks in the vertical direction, and the block configuration of the projector 502 includes twelve blocks in the horizontal direction and seven blocks in the vertical direction. Numerals outside of the frames shown in FIGS. 19A and 19B respectively represent horizontal and vertical coordinates of the blocks. A region 701 enclosed by a dashed line in FIG. 19A and a region 702 enclosed by a dashed line in FIG. 19B respectively indicate blocks (second blended blocks) where the deformed edge-blend region exists.

Since block configurations differ between the projectors, the numbers of blocks in the horizontal direction and the vertical direction which constitute the second blended blocks differ between the projectors. The correspondence determining unit 503 enlarges the region 701 which s the smaller of the regions 701 and 702 constituted by the second blended blocks of the projector 501 and the projector 502 so as to equal the larger region 702. In this case, the correspondence determining unit 503 enlarges the region 701, which is constituted by the second blended blocks of the projector 501 (receiving side), 1.5 times in the horizontal direct on and 1.4 times the vertical direction. FIG. 19C is a diagram which extracts a region 701A obtained by enlarging the region 701 constituted by the second blended blocks of the projector 501 as described above and the region 702 constituted by the second blended blocks of the projector 502 and which arranges the regions 701A and 702 side by side for easy comparison. In FIG. 19C, a dashed line in the region 701A depicts a block boundary of the region 702 and a dashed line in the region 702 depicts a block boundary of the region 701A. By comparing the region 701A and the region 702 having the same area in this manner, the correspondence determining unit 503 determines a correspondence between the second blended block of the projector 501 and the second blended block of the projector 502.

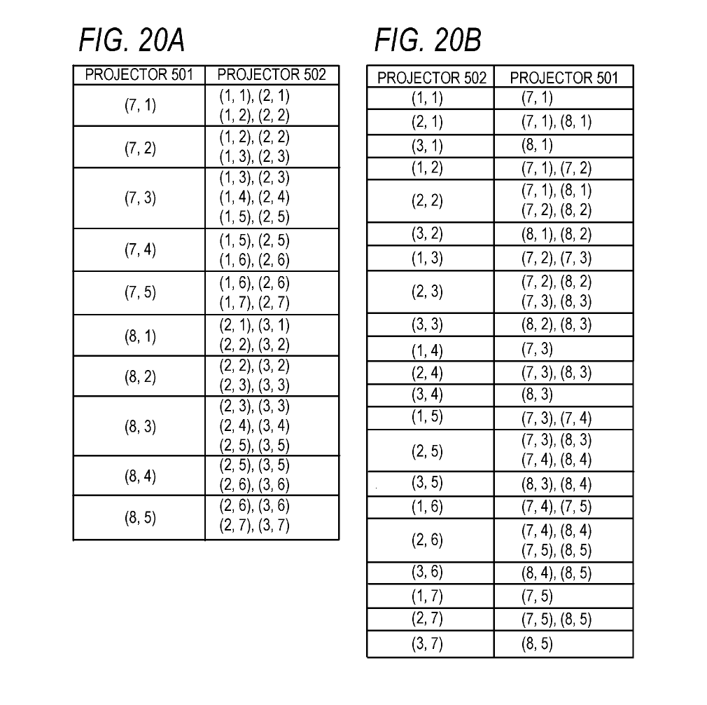

For example, FIG. 19C shows that a block (7, 1) of the projector 501 overlaps (has a shared portion) with blocks (1, 1), (2, 1), (1, 2), and (2, 2) of the projector 502. Therefore, the third characteristic value of the block (7, 1) of the projector 501 may be compared with third characteristic values of the blocks (1, 1), (2, 1), (1, 2), and (2, 2) of the projector 502. FIG. 20A shows a result of determination of a second blended block of the projector 502 to be an object of comparison of the third characteristic values for each of the second blended blocks of the projector 501 as described above. The correspondence determining unit 503 outputs information of the correspondence created in this manner to the characteristic value determining unit 10 as block correspondence information.

Based on the received block correspondence information, the characteristic value determining unit 10 determines a fourth characteristic value in a similar manner to the first embodiment by comparing third characteristic values of the projector 501 and the projector 502. For example, the third characteristic value of the block (7, 1) of the projector 501 is compared with the third characteristic values of the blocks (1, 1), (2, 1), (1, 2), and (2, 2) of the projector 502 and a largest value is adopted as the fourth characteristic value of the block (7, 1) of the projector 501.

On the other hand, processes performed by the correspondence determining unit of the projector 502 are as follows. FIG. 19C shows that a block (1, 1) of the projector 502 overlaps with a block (7, 1) of the projector 501. Therefore, the third characteristic value of the block (1, 1) of the projector 502 may be compared with the third characteristic value of the block (7, 1) of the projector 501. In addition, a block (2, 2) of the projector 502 overlaps with blocks (7, 1), (7, 2), (8, 1), and (8, 2) of the projector 501. Therefore, the third characteristic value of the block (2, 2) of the projector 502 may be compared with third characteristic values of the blocks (7, 1), (7, 2), (8, 1), and (8, 2) of the projector 501. FIG. 20B shows a result of determination of a second blended block of the projector 501 to be an object of comparison of the third characteristic values for each of the second blended blocks of the projector 502 as described above. The correspondence determining unit 503 outputs information of the correspondence created in this manner to the characteristic value determining unit 10 as block correspondence information.

According to the configuration described above, even in a multi-projection system with different settings of optical correction processes, an improvement in contrast can be achieved while maintaining reproducibility of display brightness.

While a configuration involving dividing image data into blocks respectively corresponding to a plurality of light sources and determining an emission amount of a corresponding light source for each block has been exemplified in the respective embodiments described above, a configuration which does not perform such block division may be adopted instead. In this case, a projector performs a first process of subjecting input image data (first image data) to an edge-blend process and outputting second image data and a second process of subjecting the second image data to keystone correction and outputting the corrected image data as third image data. The edge-blend process refers to a process of adjusting brightness of pixels in an edge-blend region of the first image data. The keystone correction refers to a process of deforming a shape of an image of the second image data. The projector controls, based on the first image data, an emission amount of a light source at a position corresponding to a deformed superimposition region (a deformed edge-blend region) deformed by the second process. In addition, the projector controls, based on the first image data and the third image data, an emission amount of a light source at a position corresponding to a boundary between the deformed superimposition region and other regions. Furthermore, the projector controls, based on the third image data, an emission amount of a light source at a position corresponding to regions other than the deformed superimposition region.

Moreover, while an example in which the present invention is applied to a projector which performs an edge-blend process and keystone correction on input image data has been described in the respective embodiments presented above, the present invention can also be preferably applied to a projector which does not perform keystone correction. In this case, the projector controls, based on the input image data (first image data), an emission amount of a light source at a position corresponding to a superimposition region (an edge-blend region). In addition, the projector controls, based on the first image data and image data (second image data) after subjecting the first image data to the edge-blend process, an emission amount of a light source at a position corresponding to a boundary between the superimposition region and other regions. Furthermore, the projector controls, based on the second image data, an emission amount of a light source at a position corresponding to regions other than the superimposition region.

Even in a projector configured as described above, each block can be controlled in a similar manner to the embodiments described earlier. In this case, the projector performs a first acquisition process of acquiring a first characteristic value that is a characteristic value of first image data for each block corresponding to each of a plurality of light sources. When a pixel of a superimposition region is included in a block corresponding to a light source that is an object of determination of an emission amount, the projector determines the emission amount based on the first characteristic value of the block. In addition, the projector performs a second acquisition process of acquiring a second characteristic value that is a characteristic value of second image data for each block. When a pixel of a superimposition region and a pixel of a region other than the superimposition region are included in a block corresponding to a light source that is an object of determination of an emission amount, the projector determines the emission amount based on the first characteristic value and the second characteristic value of the block. For example, when a configuration is adopted in which an emission amount of a light source is determined based on a prescribed correspondence between a characteristic value of image data and an emission amount of a light source, the emission amount can be determined based on whichever characteristic value having the larger of corresponding emission amounts of the first characteristic value and the second characteristic value. Furthermore, when a pixel of a superimposition region is not included in a block corresponding to a light source that is an object of determination of an emission amount, the projector determines the emission amount based on the second characteristic value of the block.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™) a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass cell such modifications and equivalent structures and functions.

This application claims the benefit of Japanese Patent Application No. 2016-40369, filed on Mar. 2, 2016, which is hereby incorporated by reference herein in its entirety.

What is claimed is:

1. A projection apparatus comprising:
a light-emitting unit configured to include plurality of light sources;
a control unit configured to individually control emission amounts of the plurality of light sources of the light-emitting unit;
a first processing unit configured to adjust brightness of pixels in a superimposition region, where superimposition is made with an image projected onto a screen by another projection apparatus in input first image data and output the adjusted image data as second image data; and
projecting unit configured to project light obtained by modulating light from the light-emitting unit, based on the second image data, onto the screen and displays an image, wherein
the control unit controls an emission amount of a light source at a position corresponding to the superimposition region, based on the first image data of the superimposition region.

2. The projection apparatus according to claim 1, wherein the control unit controls an emission amount of a light source at a position corresponding to a boundary between the superimposition region and another region, based on the first image data and the second image data.

3. The projection apparatus according to claim 1, wherein the control unit controls an emission amount of a light source at a position corresponding to a region other than the superimposition region, based on the second image data.

4. The projection apparatus according to claim 1 further comprising
a first acquiring unit configured to acquire a first characteristic value, which is a characteristic value of the first image data, for each block corresponding to each of the plurality of light sources, wherein
in a case where a pixel of the superimposition region is included in a block corresponding to a light source that is an object of determination of an emission amount, the control unit determines the emission amount of the light source that is the object, based on the first characteristic value of the block.

5. The projection apparatus according to claim 4, wherein
the first acquiring unit further acquires a second characteristic value, which is a characteristic value the second image data, for each block, and
in a case where a pixel of the superimposition region and a pixel of a region other than the superimposition region are included in a block corresponding to a light source that is an object of determination of an emission amount, the control unit determines the emission amount of the light source that is the object, based on the first characteristic value and the second characteristic value of the block.

6. The projection apparatus according to claim 5, wherein the control unit, determines an emission amount of the light source based on a prescribed correspondence between a characteristic value of image data and an emission amount of a light source, and determines the emission amount of the light source that is the object, based on whichever characteristic value having the larger of corresponding emission amounts of the first characteristic value and the second characteristic value.

7. The projection apparatus according to claim 4, wherein
the first acquiring unit further acquires a second characteristic value, which is a characteristic value of the second image data, for each block, and
in a case where a pixel of the superimposition region is not included in a block corresponding to a light, source that is an object of determination of an emission amount, the control unit determines the emission amount of the light source that is the object, based on the second characteristic value of the block.

8. A projection apparatus, comprising:
a light-emitting unit configured to include plurality of light sources;
a control unit configured to individually control emission amounts of the plurality of light sources of the light-emitting unit;
a first processing unit configured to adjust brightness of pixels in a superimposition region, where superimposition is made with an image projected onto a screen by another projection apparatus in input first image data and that outputs the adjusted image data as second image data;
a second processing unit configured to deform a shape of an image of the second image data and that outputs the deformed image data as third image data; and
a projecting unit configured to project light obtained by modulating light from the light-emitting unit, based on the third image data, onto the screen and displays an image, wherein
the control unit controls, based on the first image data, an emission amount of a light source at a position corresponding to a deformed superimposition region, which has been deformed by the second processing unit.

9. The projection apparatus according to claim 8, wherein the control unit controls an emission amount of a light source at a position corresponding to a boundary between the deformed superimposition region and another region, based on the first image data and the third image data.

10. The projection apparatus according to claim 8, wherein the control unit controls an emission amount of a light source at a position corresponding to a region other than the deformed superimposition region, based on the third image data.

11. The projection apparatus according to claim 8, further comprising
a first acquiring unit configured to acquire a first characteristic value, which is a characteristic value of the first image data, for each block corresponding to each of the plurality of light sources, wherein
the control unit determines, based on a first characteristic value of a block in the first image data, to which a pixel of the deformed superimposition area included in a block corresponding to a light source that is an object of determination of an emission amount belonged prior to deformation, the emission amount of the light source that is the object.

12. The projection apparatus according to claim 11, wherein in a case where a plurality of pixels of the deformed supposition region included in a block corresponding to the light source that is the object belonged to mutually different blocks in the first image data prior to deformation, the emission amount of the light source that is the object is determined based on the respective first characteristic values of the different blocks.

13. The projection apparatus according to claim 12, wherein the control unit determines an emission amount of the light source, based on a prescribed correspondence between a characteristic value of image data and an emission amount of a light source, and determines the emission amount of the light source that is the object, based on a first characteristic value with a largest corresponding emission amount among the respective first characteristic values of the different blocks.

14. The projection apparatus according to claim 11, wherein
the first acquiring unit further acquires a second characteristic value, which is a characteristic value of the third image data, for each block, and
the control unit determines, based on the first characteristic value and the second characteristic value of a block in the third image data, to which a pixel of a region other than the deformed superimposition region included in a block corresponding to a light source that is an object of determination of an emission amount belongs, the emission amount of the light source that is the object.

15. The projection apparatus according to claim 14, wherein the control unit determines an emission amount of the light source, based on a prescribed correspondence between a characteristic value of image data and an emission amount of a light source, and determines the emission amount of the light source that is the object, based on whichever characteristic value having the larger of corresponding emission amounts of the first characteristic value and the second characteristic value.

16. The projection apparatus according to claim 11, wherein
the first acquiring unit further acquires a second characteristic value, which is a characteristic value of the third image data, for each block, and
in a case where a pixel of the deformed superimposition region is not included in a block corresponding to a light source that is an object of determination of an emission amount, the control unit determines the emission amount of the light source that is the object, based on the second characteristic value of the block in the third image data.

17. The projection apparatus according to claim 8, wherein the second processing unit deforms a shape of an image of the second image data so as to correct a geometric distortion of a projection image projected onto a projection surface by the projecting unit.

18. The projection apparatus according to claim 1, further comprising
a second acquiring unit configured to acquire control information of a second light-emitting unit included in a second projection apparatus which projects a second projection image to be superimposed, in the superimposition region, with a first projection image by the projection apparatus, wherein
the control unit controls an emission amount of a light source at a position corresponding to the superimposition region, also based on the control information acquired by the second acquiring unit.

19. The projection apparatus according to claim 4, further comprising
a second acquiring unit configured to acquire control information of a second light-emitting unit included in a second projection apparatus which projects a second projection image to be superimposed, in the superimposition region, with a first projection image by the projection apparatus, wherein
the control information is information on a characteristic value of image data in each block corresponding to each of a plurality of second light sources included in the second light-emitting unit, and
the control unit controls an emission amount of a light source at a position corresponding to the superimposition region, also based on the control information acquired by the second acquiring unit.

20. The projection apparatus according to claim 19, wherein a size of a block corresponding to the second light source in the control information is the same as a size of a block corresponding to the light source of the light-emitting unit of the projection apparatus.

21. The projection apparatus according to claim 20, wherein the control unit determines an emission amount of the light source, based on a prescribed correspondence between a characteristic value of image data and an emission amount of a light source, and determines the emission amount of the light source that is the object based on whichever characteristic value having the larger of corresponding emission amounts of a characteristic value acquired by the first acquiring unit and a characteristic value acquired by the second acquiring unit.

22. The projection apparatus according to claim 19, wherein a size of a block corresponding to the second light source in the control information differs from a size of a block corresponding to the light source of the light-emitting unit of the projection apparatus

23. The projection apparatus according to claim 22, wherein the control unit determines an emission amount of the light source, based on a prescribed correspondence between a characteristic value of image data and an emission amount of a light source, and determines the emission amount of the light source that is an object of determination of an emission amount, based on whichever characteristic value the larger of corresponding emission amounts of a characteristic value acquired by the first acquiring unit and a characteristic value acquired by the second acquiring unit with respect to a block corresponding to the second light source which has a shared portion with a block corresponding to the light source that is the object.

24. The projection apparatus according to claim 4, wherein in a case where an image of a block corresponding to the light source that is the object is determined as an image, in which a high-brightness object with a small area exists against a dark background, based on a characteristic value used in a case where determining an emission amount of the light source, the control unit reduces an emission amount based on the characteristic value.

25. The projection apparatus according to claim 4, wherein the characteristic value of each block is a maximum value and an average value of gradation values of image data of the block.

26. The projection apparatus according to claim 1, further comprising:
a modulating unit configured to modulate light from the light-emitting unit; and
a correcting unit configured to calculate a brightness distribution of light incident to the modulating unit, based on the emission amount of the light source determined by the control unit, and correct the second image data or the third image data, based on the brightness distribution, wherein
the modulating unit modulates light from the light-emitting unit, based on the second image data or the third image data corrected by the correcting unit.

27. A control method of a projection apparatus including a light-emitting unit having a plurality of light sources, the control method comprising:
controlling individually emission amounts of the plurality of light sources of the light-emitting unit;
adjusting brightness of pixels in a superimposition region, where superimposition is made with an image projected onto a screen by another projection apparatus, in input first image data and outputting the adjusted image data as second image data; and
projecting light obtained by modulating light from the light-emitting unit, based on the second image data, onto the screen and displaying an image, wherein
in the control of emission amounts, an emission amount of a light source at a position corresponding to the superimposition region is controlled based on the first image data of the superimposition region.

28. A control method of a projection apparatus including a light-emitting unit having a plurality of light sources, the control method comprising:
controlling individually emission amounts of the plurality of light sources of the light-emitting unit;
adjusting brightness of pixels in a superimposition region, where superimposition is made with an image projected onto a screen by another projection apparatus, in input first image data and outputting the adjusted image data as second image data;
deforming a shape of an image of the second image data and outputting the deformed image data as third image data; and
projecting light obtained by modulating light from the light-emitting unit, based on the third image data, onto the screen and displaying an image, wherein
in the control of emission amounts, an emission amount of a light source at a position corresponding to a deformed superimposition region deformed in the deforming is controlled based on the first image data.
